(19) United States
(12) Patent Application Publication
(10) Pub. No.: US 2026/0074583 A1
(43) Pub. Date: Mar. 12, 2026

(54) MOTOR

(71) Applicant: MINEBEA MITSUMI Inc., Kitasaku-gun, Nagano (JP)

(72) Inventors: Kouji KEBUKAWA, Kitasaku-gun, Nagano (JP); Takayuki YAMASAKI, Kitasaku-gun, Nagano (JP); Kentaro SUZUKI, Kitasaku-gun, Nagano (JP)

(21) Appl. No.: 19/105,918

(22) PCT Filed: Aug. 2, 2023
(86) PCT No.: PCT/JP2023/028258

§ 371 Date: Feb. 24, 2025

(30) Foreign Application Priority Data
Aug. 29, 2022 (JP) 2022-136350
Nov. 14, 2022 (JP) 2022-182015

(51) Int. Cl. H02K 7/04; H02K 1/14; H02K 1/2706; H02K 7/08

(52) U.S. Cl. CPC H02K 7/04; H02K 1/146; H02K 1/2706; H02K 7/083; H02K 2213/12

(57) ABSTRACT

A motor includes, for example, a shaft, a magnet, a coil, a first bearing disposed at one end part side of the shaft in an axial direction, a second bearing disposed at the other end part side of the shaft in the axial direction, a cover fixed to the second bearing and disposed inside the coil in a radial direction, a holder fixed to the first bearing and an elastic member held by the holder. The elastic member is disposed between the cover and the holder in a longitudinal direction of the shaft.

### TECHNICAL FIELD

The present invention relates to a motor.

### BACKGROUND ART

Conventionally, there is known a motor including a bearing device disposed with bearings at both ends of a shaft. In the bearing device, both of the bearings are preloaded in directions away from each other in an axial direction. For example, Patent Document 1 discloses a rolling bearing device including a preload unit including an elastic member.

### CITATION LIST

### Patent Literature

Patent Document 1: JP 04-82425 UM-A

### SUMMARY OF INVENTION

### Technical Problem

This type of motor needs to increase coaxiality of a rotor and a stator. An example of an object of the present invention is to increase coaxiality of a motor.

### Solution to Problem

A motor according to the present invention includes a shaft, a magnet, a coil, a first bearing disposed at a side of one end part of the shaft in an axial direction, a second bearing disposed at a side of the other end part of the shaft in the axial direction, a cover fixed to the second bearing and disposed inside the coil in a radial direction, a holder fixed to the first bearing, and an elastic member held by the holder. The elastic member is disposed between the cover and the holder in a longitudinal direction of the shaft.

Another motor according to the present invention includes an annular yoke including two end surfaces in an axial direction. This motor further includes a stator including a plurality of magnetic pole parts, a plurality of spokes coupled to the plurality of magnetic pole parts and an inner circumferential part of the annular yoke, and a plurality of coils wound around the plurality of spokes. In this motor, each of the plurality of spokes is attachable to and detachable from the annular yoke, the annular yoke and each of the plurality of spokes are formed of a plurality of magnetic bodies stacked in the axial direction, and the plurality of magnetic bodies forming the spokes are biased from a side of one end surface toward a side of the other end surface of the two end surfaces of the annular yoke.

Another motor according to the present invention may further include at least one of the following configurations.

The plurality of magnetic bodies forming the spokes may be biased in the radial direction. The annular yoke may include a plurality of openings disposed in a circumferential direction, each of the plurality of openings may include an inner surface at the side of the one end surface of the annular yoke and an inner surface at the side of the other end surface of the annular yoke, the plurality of spokes may extend in the radial direction and pass through the plurality of openings, and the plurality of magnetic bodies forming the spokes may be biased from the inner surface at the side of the one end surface of the annular yoke toward the inner surface at the side of the other end surface of the annular yoke. When the motor includes the plurality of openings, the number of the plurality of magnetic bodies forming the spokes may be less than the number of a plurality of magnetic bodies forming the plurality of openings of the plurality of magnetic bodies forming the annular yoke. The plurality of spokes may include a plurality of hole parts extending in the axial direction, and members inserted into the plurality of hole parts may bias the plurality of magnetic bodies forming the spokes. When the motor includes the plurality of hole parts, each of the plurality of hole parts may be adjacent to the annular yoke in the radial direction. When each of the plurality of hole parts is adjacent to the annular yoke in the radial direction, each of the members may contact a side surface of the annular yoke. When each of the members contacts the side surface of the annular yoke, each of the members may include a side surface inclined relative to a side surface of the annular yoke. A thickness in the axial direction of each of the plurality of magnetic bodies forming the spokes may be equal to a thickness in the axial direction of each of the plurality of magnetic bodies forming the annular yoke.

### BRIEF DESCRIPTION OF DRAWINGS

FIG. 1 is a cross-sectional view of a motor according to a first embodiment being one example of the present invention.

FIG. 2 is a cross-sectional view of only a bearing device in the motor according to the first embodiment being one example of the present invention.

FIG. 3 is a cross-sectional view of only a bearing device in the motor according to a second embodiment being one example of the present invention.

FIG. 4 is a cross-sectional view of only a bearing device in the motor according to a third embodiment being one example of the present invention.

FIG. 5 is a cross-sectional view of only a bearing device in the motor according to a fourth embodiment being one example of the present invention.

FIG. 6 is a cross-sectional view of only a bearing device in the motor according to a fifth embodiment being one example of the present invention.

FIG. 7 is a perspective view illustrating a motor according to a sixth embodiment being another example of the present invention.

FIG. 8 is a plan view of the motor illustrated in FIG. 7 as viewed from one side in an axial direction.

FIG. 9 is a cross-sectional view, in a radial direction, of the motor illustrated in FIG. 7.

FIG. 10 is a cross-sectional view in the axial direction of the motor illustrated in FIG. 7.

FIG. 11 is a plan view illustrating a state of the motor illustrated in FIG. 8 with the bearing device removed.

FIG. 12 is a cross-sectional view taken along line A-A illustrated in FIG. 11.

FIG. 12A is a view schematically illustrating a state of a side surface of each magnetic body.

FIG. 13 is a perspective view illustrating a state with one of a plurality of stator members illustrated in FIG. 11 removed from a yoke.

FIG. 14 is a plan view illustrating a state with one of the plurality of stator members illustrated in FIG. 11 being passed through an opening in the yoke.

FIG. 15 is a perspective view illustrating a pressing member illustrated in FIG. 7.

FIG. 16 is a side view illustrating the pressing member illustrated in FIG. 15.

FIG. 17 is a perspective view illustrating a state at the start of insertion of the pressing member illustrated in FIG. 15 into a hole part of the yoke.

FIG. 18 is a perspective view illustrating a motor according to a seventh embodiment being another example of the present invention.

FIG. 19 is a perspective view illustrating the pressing member illustrated in FIG. 18.

FIG. 20 is a bottom view illustrating the pressing member illustrated in FIG. 18.

### DESCRIPTION OF EMBODIMENTS

In the descriptions of the first embodiment to the fifth embodiment of the present invention, for the purpose of illustration, an arrow a direction along an axis X in each drawing (direction from a second bearing 113b toward a first bearing 113a) is defined as a lower side or one side. An arrow b direction (direction from the first bearing 113a toward the second bearing 113b) along the axis X is defined as an upper side or the other side. Here, the direction of the arrows a, b is referred to as an up-down direction or an axial direction. However, the up-down direction does not necessarily coincide with a vertical direction. The direction of arrows c, d is referred to as a radial direction. The direction of the arrow c extending away from the axis X is referred to as an outer side, and the direction of the arrow d extending closer to the axis X is referred to as an inner side.

### First Embodiment

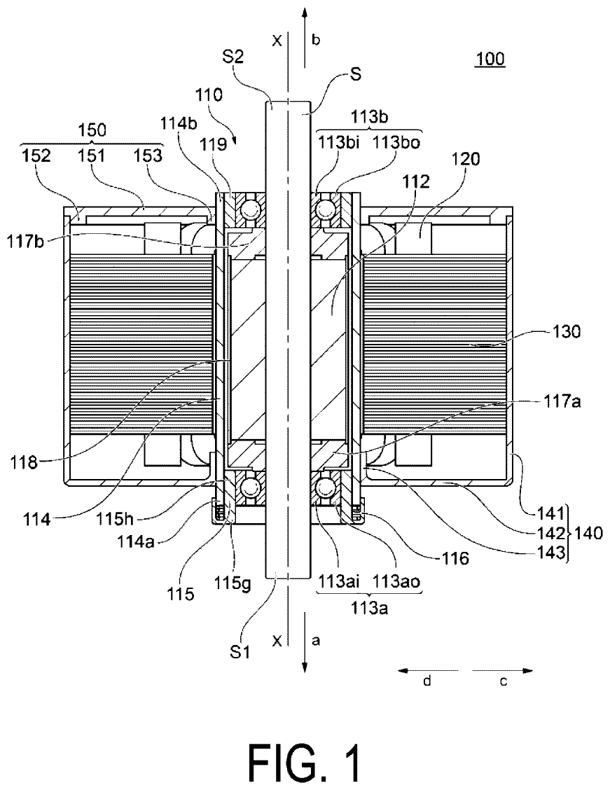

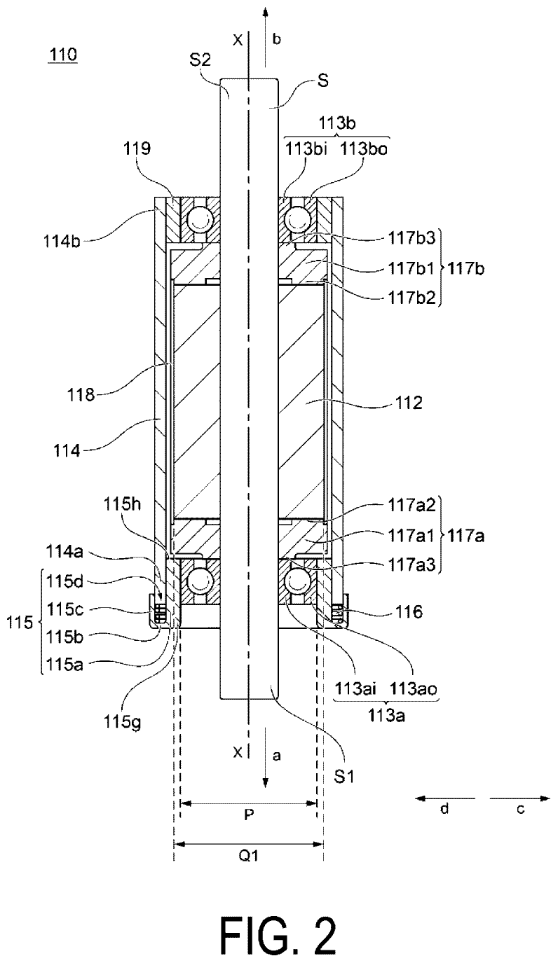

A first embodiment being one example of the present invention will be described below with reference to the drawings. FIG. 1 is a cross-sectional view cut along a plane of a motor 100 according to the present embodiment, the plane including the axis X. FIG. 2 is a view illustrating only a bearing device 110 extracted from FIG. 1.

As illustrated in FIG. 1, the motor 100 includes the bearing device 110, a coil 120, a magnetic body 130, a case 140, and a lid 150. In the present embodiment, the magnetic body 130 is constituted by a plurality of magnetic bodies (electromagnetic steel plates) stacked in the axial direction. The case 140 is a tubular member including a bottom part and open at the other side in the axial direction (arrow b direction). The case 140 includes a tubular part (cylindrical part) 141, a bottom part 142, and a projecting part 143 having an annular shape. The cylindrical part 141 is a part having a cylindrical shape with the axis X as a central axis. The bottom part 142 is a flat plate part having an annular shape and extending from an end part of the cylindrical part 141 at the one side in the axial direction (arrow a direction) to the inner side in the radial direction (arrow d direction). The projecting part 143 is a part having a cylindrical shape extending from an end part of the bottom part 142 at the inner side in the radial direction (arrow d direction) toward the other side in the axial direction (arrow b direction). In the axial direction, a length of the cylindrical part 141 is larger than a length of the projecting part 143.

The lid 150 is a lid-like member covering the opening at the other side in the axial direction (arrow b direction) of the cylindrical part 141 of the case 140, and includes a flat plate part 151, an outer circumferential part (engagement part) 152, and an inner circumferential part (protruding part) 153. The flat plate part 151 is a part having an annular shape with the axis X as a central axis. An outer circumference and an inner circumference of the flat plate part 151 have the same or substantially the same size (outer diameter and inner diameter) as the case 140 in the radial direction. The engagement part 152 is a part having an annular shape projecting to the one side in the axial direction (arrow a direction) at a slightly inner side in the radial direction (arrow d direction) from an end part of the flat plate part 151 at the outer side in the radial direction (arrow c direction). The protruding part 153 is a part having a cylindrical shape projecting to the one side in the axial direction (arrow a direction) from an end part of the flat plate part 151 at the inner side in the radial direction (arrow d direction). In the axial direction, a length of the engagement part 152 is substantially equal to a length of the protruding part 153.

The engagement part 152 of the lid 150 is engaged with an end part (outer circumferential end part) of the cylindrical part 141 of the case 140 at the other side in the axial direction (arrow b direction). A size (outer diameter) of the engagement part 152 of the lid 150 in the radial direction is equal or substantially equal to a size (inner diameter) of the cylindrical part 141 of the case 140, and the engagement part 152 of the lid 150 is inserted into an inner side in the radial direction (arrow d direction) of the end part of the cylindrical part 141 of the case 140 at the other side in the axial direction (arrow b direction). The engagement part 152 of the lid 150 is fixed to the cylindrical part 141 of the case 140 by adhesion or press-fitting.

An inner diameter of the projecting part 143 of the case 140 is equal to an inner diameter of the protruding part 153 of the lid 150. In the radial direction, an outer surface of a cover 114 (described below), having a cylindrical shape, of the bearing device 110 is fixed to an inner surface of the projecting part 143 of the case 140 and an inner surface of the protruding part 153 of the lid 150 with an adhesive or the like. The coil 120 and the magnetic body 130 are accommodated in a cylindrical space defined by the case 140, the lid 150, and the cover 114 of the bearing device 110. The cylindrical space has the axis X as a central axis. Accordingly, in the radial direction, the cover 114 of the bearing device 110 is disposed inside the coil 120 (in the arrow d direction).

The magnetic body 130 is formed of a stacked body with a plurality of electromagnetic steel plates formed of a soft magnetic material and stacked in the axial direction. The magnetic body 130 is connected to a surface of the cylindrical part 141 of the case 140 at the inner side in the radial direction (arrow d direction), and extends toward the inner side in the radial direction (arrow d direction) up to the vicinity of the cover 114 of the bearing device 110. In the motor 100 according to the present embodiment, six magnetic bodies 130 are arranged radially at equal angular intervals in a circumferential direction.

However, the number of the magnetic bodies 130 is not limited to six. The coil 120 is wound around each magnetic body 130 through an insulator (not illustrated).

As illustrated in FIG. 2, the bearing device 110 includes a shaft S, a magnet 112, the first bearing 113a, the second bearing 113b, the cover 114, a holder 115, and an elastic member 116. In the radial direction, the shaft S, the magnet 112, the first bearing 113a, and the second bearing 113b are disposed inside the cover 114. That is, in the radial direction, the cover 114 has a sleeve shape covering the shaft S, the magnet 112, the first bearing 113a, and the second bearing 113b. Furthermore, the cover 114 includes one end part 114a at the first bearing 113a side and another end part 114b at the second bearing 113b side. The cover 114 is formed of ceramic, for example. However, the cover 114 may be formed of another material such as a non-magnetic metal or resin.

The shaft S is a member having a columnar shape or a substantially columnar shape extending in the axial direction. The shaft S includes one end part S1 at the first bearing 113a side and another end part S2 at the second bearing 113b side. In the axial direction, the first bearing 113a is disposed at the one end part S1 side of the shaft S. In the axial direction, the second bearing 113b is disposed at the other end part S2 side of the shaft S.

The first bearing 113a is a ball bearing including an inner ring 113ai, an outer ring 113ao, and rolling bodies. The first bearing 113a is not limited to a ball bearing having this form but may be any of various other bearings such as, for example, a sleeve bearing, and a ball bearing including balls fitted in recesses provided at an outer circumferential surface of the shaft and an outer ring. The inner ring 113ai of the first bearing 113a is press-fitted or bonded to a surface of the shaft S at an outer side in the radial direction (arrow c direction). Thus, the inner ring 113ai of the first bearing 113a is fixed to the shaft S.

The second bearing 113b has the same dimensions and configuration as the first bearing 113a. The second bearing 113b is a ball bearing including an inner ring 113bi, an outer ring 113bo, and rolling bodies. The second bearing 113b is not limited to a ball bearing having this form but may be any of various other bearings such as, for example, a sleeve bearing, and a ball bearing including balls fitted in recesses provided at the outer circumferential surface of the shaft and an outer ring. The inner ring 113bi of the second bearing 113b is press-fitted or bonded to the surface of the shaft S at the outer side in the radial direction (arrow c direction). Thus, the inner ring 113bi of the second bearing 113b is fixed to the shaft S.

The other end part 114b of the cover 114 having a cylindrical shape is fixed to an outer side (in the arrow c direction) of the outer ring 113bo of the second bearing 113b in the radial direction through a spacer 119 having an annular shape. In the axial direction, a length of the spacer 119 is equal or substantially equal to a length of the second bearing 113b. In the radial direction, an inner diameter of the spacer 119 is equal or substantially equal to an outer diameter of the outer ring 113bo of the second bearing 113b, and an outer diameter of the spacer 119 is equal or substantially equal to an inner diameter of the cover 114. A surface of the outer ring 113bo of the second bearing 113b at the outer side in the radial direction (arrow c direction) and a surface of the spacer 119 at the inner side in the radial direction (arrow d direction) are fixed to each other, and the surface of the spacer 119 at the outer side in the radial direction (arrow c direction) and a surface of the cover 114 at the inner side in the radial direction (arrow d direction) are fixed to each other, by press-fitting or bonding. The second bearing 113b relatively rotatably supports the shaft S with respect to the cover 114.

An end part (other end part 115h) of the holder 115 at the other side in the axial direction (arrow b direction) is fixed to an outer side (arrow c direction) of the outer ring 113ao of the first bearing 113a in the radial direction. A surface of the outer ring 113ao of the first bearing 113a at the outer side in the radial direction (arrow c direction) and a surface of an inner circumferential part 115a described below of the holder 115 at the inner side in the radial direction (arrow d direction) are fixed to each other, by press-fitting or bonding. The first bearing 113a relatively rotatably supports the shaft S with respect to the holder 115.

The holder 115 has a three-dimensional shape obtained by rotating a cross section having a substantially J-like shape about the axis X. The holder 115 is formed of a metal such as aluminum, copper, or iron. However, the holder 115 may be formed of other materials such as resin. The holder 115 may be formed of a material softer than the material of the cover 114. The holder 115 includes the inner circumferential part 115a, a connection part 115b, and an outer circumferential part 115c. This connection part 115b forms one end part 115g of the holder 115, and the holder 115 includes the one end part 115g and the other end part 115h.

The inner circumferential part 115a is a part having a cylindrical shape extending in the axial direction. In the radial direction, a thickness of the inner circumferential part 115a is equal or substantially equal to a thickness of the spacer 119. In the radial direction, an inner diameter and an outer diameter of the inner circumferential part 115a are equal or substantially equal to the inner diameter and the outer diameter of the spacer 119, respectively. In the axial direction, the inner circumferential part 115a has a length greater than a length of the first bearing 113a.

The connection part 115b is a part having an annular shape extending to the outer side in the radial direction (arrow c direction) from an end part of the inner circumferential part 115a at the one side in the axial direction (arrow a direction). The outer circumferential part 115c is a part having a cylindrical shape extending from an end part of the connection part 115b at the outer side in the radial direction (arrow d direction) toward the other side in the axial direction (arrow b direction). In the axial direction, a length of the outer circumferential part 115c is smaller than the length of the inner circumferential part 115a.

In the holder 115, a space having an annular shape surrounded by the inner circumferential part 115a, the connection part 115b, and the outer circumferential part 115c is referred to as an accommodating part 115d. In the axial direction, the accommodating part 115d has a depth corresponding to the length of the outer circumferential part 115c. In the radial direction, a width of the accommodating part 115d, that is, a distance between the inner circumferential part 115a and the outer circumferential part 115c is equal to a thickness of the cover 114 or slightly larger than the thickness of the cover 114.

The accommodating part 115d of the holder 115 accommodates the elastic member 116. That is, the holder 115 holds the elastic member 116. The one end part 114a of the cover 114 is inserted into the accommodating part 115d from the other side of the accommodating part 115d in the axial direction (arrow b direction). A contact part between the cover 114 and the holder 115 is slidable in the axial direction. The elastic member 116 is disposed between the cover 114 and the holder 115 in the axial direction (longitudinal direction of the shaft S), that is, between the one end part 114a of the cover 114 and a surface of the connection part 115b of the holder 115 at the other side in the axial direction (arrow b direction) (that is, a bottom surface forming the accommodating part 115d). The elastic member 116 contacts both the one end part 114a of the cover 114 and the surface of the connection part 115b of the holder 115 at the other side in the axial direction (arrow b direction) and is held by both.

In the present embodiment, the elastic member 116 is a coil having a substantially cylindrical, spiral shape with the axis X as a central axis. However, the elastic member 116 may be a member formed of a material having rubber elasticity and having various shapes.

Examples of the material having rubber elasticity include thermosetting elastomers such as natural rubber and synthetic rubber, and thermoplastic elastomers such as styrene-based, olefin-based, vinyl chloride-based, acryl-based, polyamide-based, polyester-based, and polyurethane-based elastomers. A plurality of the elastic members 116 may be disposed at the accommodating part 115d, side by side in the circumferential direction.

The elastic member 116 biases the cover 114 and the holder 115 in the axial direction. More specifically, in the axial direction, the elastic member 116 presses the cover 114 and the holder 115 in directions away from each other. That is, the elastic member 116 presses the cover 114 toward the upper side in the axial direction (arrow b direction). The elastic member 116 presses the holder 115 toward the lower side in the axial direction (arrow b direction).

As described above, the other end part 114b of the cover 114 having a cylindrical shape is fixed to the outer side (in the arrow c direction) of the outer ring 113bo of the second bearing 113b in the radial direction through the spacer 119 having an annular shape, and the holder 115 is fixed to the outer side (in the arrow c direction) of the outer ring 113ao of the first bearing 113a in the radial direction. Thus, the elastic member 116 applies preloads to the outer ring 113ao of the first bearing 113a and the outer ring 113bo of the second bearing 113b so as to increase distance from each other in the axial direction.

In the present embodiment, the magnet 112 is a cylindrical permanent magnet having four magnetic poles. In the cylindrical permanent magnet, different magnetic poles (S poles and N poles) are alternately magnetized in the circumferential direction. However, the number of magnetic poles of the magnet 112 is not limited to four and may be another number. In the radial direction, an inner diameter of the magnet 112 is equal to an outer diameter of the shaft S or slightly larger than the outer diameter of the shaft S. The magnet 112 is fixed to the surface of the shaft S at the outer side in the radial direction (arrow c direction) by adhesion or press-fitting. In the axial direction, the magnet 112 is disposed between the first bearing 113a and the second bearing 113b so as to be separated from the first bearing 113a and the second bearing 113b by predetermined distances. A size (outer diameter) Q1 of the magnet 112 in the radial direction is larger than a size (outer diameter) P of the first bearing 113a and the second bearing 113b in the radial direction.

A protective member 118 having a cylindrical shape is provided so as to cover a surface (outer surface) of the magnet 112 at the outer side in the radial direction (arrow c direction). The protective member 118 is provided, for example, to prevent breakage or scattering of the magnet 112. However, the motor 100 does not need to include the protective member 118. In the radial direction, a surface of the protective member 118 at the outer side (in the arrow c direction) and the surface of the cover 114 at the inner side (in the arrow d direction) are spaced apart and face each other.

A member (first pressing member) 117a is disposed between the magnet 112 and the first bearing 113a in the axial direction. A member (second pressing member) 117b is disposed between the magnet 112 and the second bearing 113b in the axial direction. The first pressing member 117a and the second pressing member 117b have the same shape and the same dimensions and are disposed symmetrical with respect to a plane orthogonal to the axis X while sandwiching the magnet 112.

The first pressing member 117a and the second pressing member 117b include annular parts 117a1 and 117b1, contact parts 117a2 and 117b2, and projecting parts 117a3 and 117b3, respectively. In the radial direction, an inner diameter of the annular parts 117a1 and 117b1 is equal to the outer diameter of the shaft S or is slightly larger than the outer diameter of the shaft S. The annular parts 117a1 and 117b1 are fixed to the surface of the shaft S at the outer side in the radial direction (arrow c direction) by bonding or press-fitting. In the radial direction, an outer diameter of the annular parts 117a1 and 117b1 is slightly larger than an outer diameter of the magnet 112 and is equal or substantially equal to an outer diameter of the protective member 118.

The contact parts 117a2 and 117b2 are parts having an annular shape, projecting in the axial direction from surfaces of the annular parts 117a1 and 117b1 close to the magnet 112, and contacting the magnet 112. The contact parts 117a2 and 117b2 project from regions of the surfaces of the annular parts 117a1 and 117b1 on sides close to the magnet 112, near the outer side in the radial direction (arrow c direction), respectively.

The projecting parts 117a3 and 117b3 are parts having an annular shape, projecting in the axial direction from surfaces of the annular parts 117a1 and 117b1 away from the magnet 112, and contacting the inner ring 113ai of the first bearing 113a and the inner ring 113bi of the second bearing 113b, respectively. The projecting parts 117a3 and 117b3 project from respective regions of the annular parts 117a1 and 117b1 at the inner side in the radial direction (arrow d direction).

The first pressing member 117a and the second pressing member 117b press the inner ring 113ai of the first bearing 113a and the inner ring 113bi of the second bearing 113b, respectively. The first pressing member 117a and the second pressing member 117b are formed of a metal such as copper. The first pressing member 117a and the second pressing member 117b may be formed of other materials but are preferably formed of heavy metals for serving as balancers for adjusting a rotational balance of the shaft S.

The motor 100 is a brushless DC motor of an inner rotor type. When the motor 100 is operated, the shaft S, the magnet 112, the inner ring 113ai of the first bearing 113a, the inner ring 113bi of the second bearing 113b, the first pressing member 117a, the second pressing member 117b, and the protective member 118 integrally rotate.

The motor 100 according to the present embodiment can be manufactured by a method of assembling the configuration at the stator side, that is, the coil 120, the magnetic body 130, the case 140, and the lid 150, and then inserting the separately assembled bearing device 110. Thus, both coaxiality between the rotor side and the stator side and coaxiality between the first bearing 113a and the second bearing 113b can be enhanced.

In the motor 100 according to the present embodiment, preloads are applied to the outer ring 113ao of the first bearing 113a and the outer ring 113bo of the second bearing 113b so as to increase distance from each other in the axial direction. Thus, the motor 100 has a high resonant frequency and is suitable for high-speed rotation applications. The preloads are applied by the elastic member 116 disposed between the cover 114 and the holder 115.

Accordingly, the motor 100 according to the present embodiment does not need to include a spring between the outer ring 113ao of the first bearing 113a and the outer ring 113bo of the second bearing 113b, creating room in an internal space of the cover 114 and making it possible to increase the outer diameter of the magnet 112 and design a motor having a large torque.

### Second Embodiment

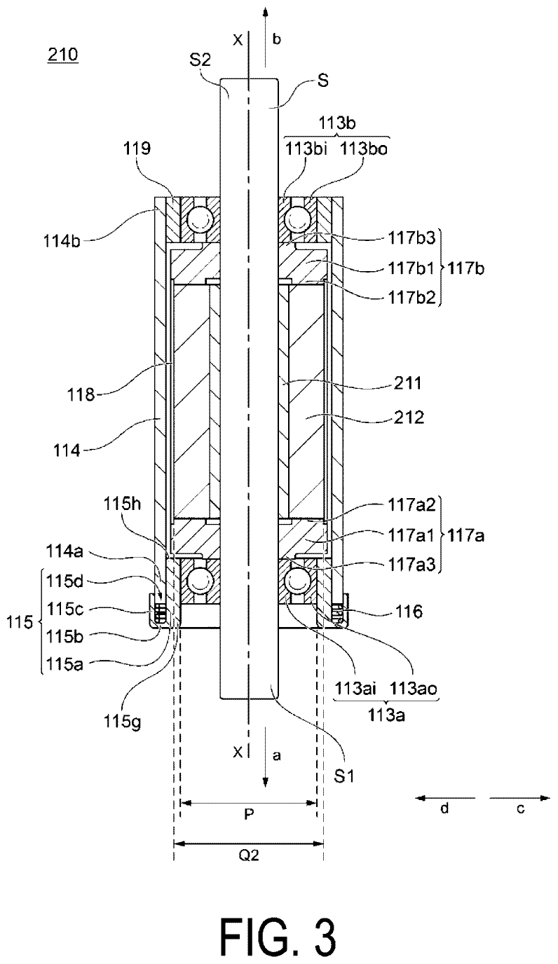

Next, a second embodiment being one example of the present invention will be described with reference to the drawings. FIG. 3 is a cross-sectional view of only a bearing device 210 of a motor according to the present embodiment. The motor according to the present embodiment has a configuration similar to the configuration of the motor 100 according to the first embodiment except that the bearing device 210 is provided instead of the bearing device 110. The bearing device 210 has a configuration similar to the configuration of the bearing device 110 of the motor 100 according to the first embodiment except that the bearing device 210 includes a yoke 211 and a magnet 212 instead of the magnet 112. Members and components having the same functions and configurations as the members and components of the first embodiment are given the same reference signs of the first embodiment, and detailed descriptions of the members and components will be omitted below.

In the present embodiment, the magnet 212 is a permanent magnet having a cylindrical shape and having four magnetic poles. In the permanent magnet, different magnetic poles (S poles and N poles) are alternately magnetized in a circumferential direction. However, the number of the magnetic poles of the magnet 212 is not limited to four and may be another number. In the radial direction, an inner diameter of the magnet 212 is larger than the outer diameter of the shaft S. An outer diameter of the magnet 212 is, for example, equal to the outer diameter of the magnet 112 of the motor 100 according to the first embodiment. The magnet 212 is fixed to the shaft S through the yoke 211 having a cylindrical shape.

In the axial direction, a length of the yoke 211 is equal to or substantially equal to a length of the magnet 212. In the radial direction, an inner diameter of the yoke 211 is equal to the outer diameter of the shaft S or slightly larger than the outer diameter of the shaft S. In the radial direction, an outer diameter of the yoke 211 is equal to the inner diameter of the magnet 212 or slightly smaller than the inner diameter of the magnet 212. The surface of the shaft S at the outer side in the radial direction (arrow c direction) and a surface of the yoke 211 at the inner side in the radial direction (arrow d direction) are fixed to each other, and a surface of the yoke 211 at the outer side in the radial direction (arrow c direction) and a surface of the magnet 212 at the inner side in the radial direction (arrow d direction) are fixed to each other, by press-fitting or bonding.

In the axial direction, the yoke 211 and the magnet 212 are disposed between the first bearing 113a and the second bearing 113b so as to be separated from the first bearing 113a and the second bearing 113b. A size (outer diameter) Q2 of the magnet 212 in the radial direction is larger than the size (outer diameter) P of the first bearing 113a and the second bearing 113b in the radial direction.

The motor according to the present embodiment has a high coaxiality and a large torque on the basis of a principle similar to the matters described above in the motor 100 according to the first embodiment. Fixing the magnet 212 to the shaft S through the yoke 211 can prevent cracking of the magnet 212 and easily magnetize the magnet 212.

### Third Embodiment

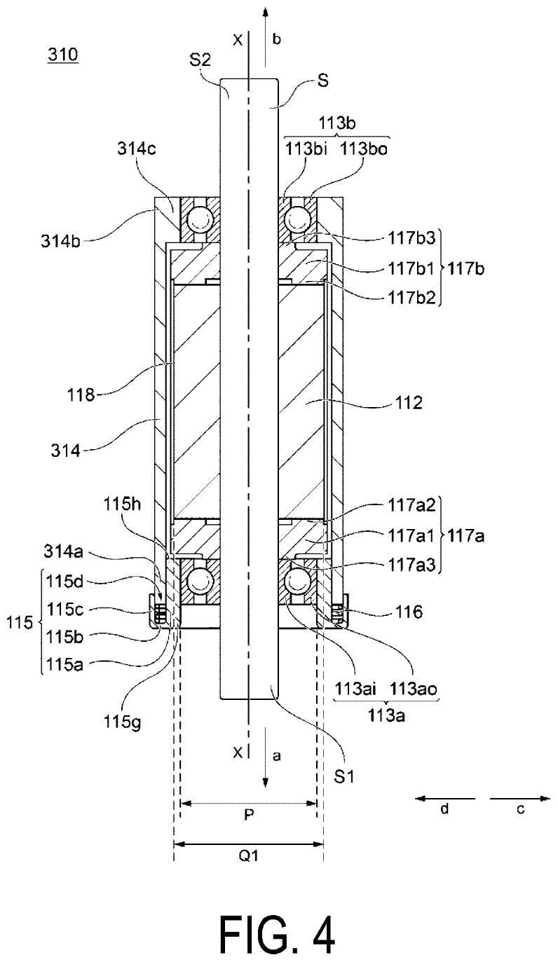

Next, a third embodiment being one example of the present invention will be described with reference to the drawings. FIG. 4 is a cross-sectional view of only a bearing device 310 in the motor according to the present embodiment. The motor according to the present embodiment has a configuration similar to the configuration of the motor 100 according to the first embodiment except that the bearing device 310 is provided instead of the bearing device 110. The bearing device 310 has a configuration similar to the configuration of the bearing device 110 of the motor 100 according to the first embodiment except that the bearing device 310 does not include the spacer 119 and includes a cover 314 instead of the cover 114. Members and components having the same functions and configurations as the members and components of the first embodiment are given the same reference signs of the first embodiment, and detailed descriptions of the members and components will be omitted below.

In the present embodiment, the cover 314 of the bearing device 310 has a shape integrating the cover 114 and the spacer 119 of the motor 100 according to the first embodiment. The cover 314 includes one end part 314a at the first bearing 113a side and another end part 314b at the second bearing 113b side. The cover 314 includes a thick part 314c at the other end part 314b. The thick part 314c has an equivalent outer diameter and a small inner diameter as compared with other parts of the cover 314.

In the radial direction, the thick part 314c of the cover 314 is directly fixed to the outer side (in the arrow c direction) of the outer ring 113bo of the second bearing 113b. In the axial direction, a length of the thick part 314c is equal or substantially equal to the length of the second bearing 113b. The surface of the outer ring 113bo of the second bearing 113b at the outer side in the radial direction (arrow c direction) and a surface of the thick part 314c of the cover 314 at the inner side in the radial direction (arrow d direction) are fixed to each other by press-fitting or bonding.

The motor according to the present embodiment has a high coaxiality and a large torque on the basis of a principle similar to the matters described above in the motor 100 according to the first embodiment. The motor according to the present embodiment has a small number of components as compared with the number of components of the motor 100 according to the first embodiment and can be easily assembled.

### Fourth Embodiment

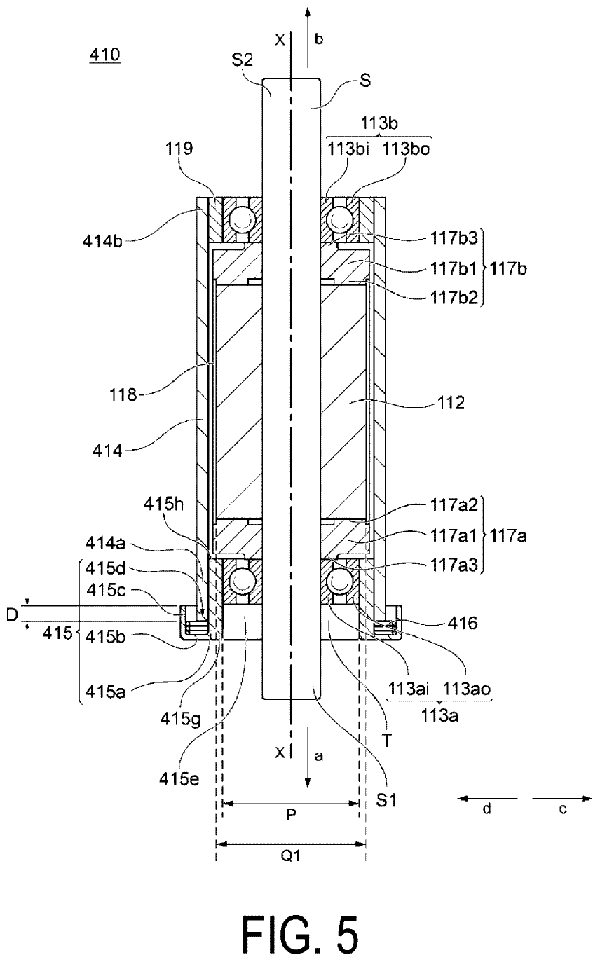

Next, a fourth embodiment being one example of the present invention will be described with reference to FIG. 5. FIG. 5 is a cross-sectional view of only a bearing device 410 of the motor according to the present embodiment. The motor according to the present embodiment has a configuration similar to the configuration of the motor 100 according to the first embodiment except that the bearing device 410 is provided instead of the bearing device 110. The bearing device 410 has the same configuration as the configuration of the bearing device 110 of the motor 100 according to the first embodiment except for including a cover 414 instead of the cover 114, a holder 415 instead of the holder 115, and an elastic member 416 instead of the elastic member 116. Members and components having the same functions and configurations as the members and components of the first embodiment are given the same reference signs of the first embodiment, and detailed descriptions of the members and components will be omitted below.

The cover 414 includes one end part 414a at the first bearing 113a side and another end part 414b at the second bearing 113b side. In the axial direction, the one end part 414a of the cover 414 extends further to the one side than an end surface of the first bearing 113a at the one side in the axial direction. The holder 415 has a three-dimensional shape obtained by rotating a cross section having a substantially J-like shape about the axis X. The holder 415 includes an inner circumferential part 415a, a connection part 415b, and an outer circumferential part 415c. This connection part 415b forms one end part 415g of the holder 415, and the holder 415 includes the one end part 415g and another end part 415h. A size of the connection part 415b of the holder 415 in the radial direction is larger than a size of the connection part 115b of the holder 115 in the radial direction in the first embodiment. The cover 414, the holder 415, and the elastic member 416 have configurations similar to the configurations of the cover 114, the holder 115, and the elastic member 116 in the first embodiment, respectively, unless otherwise specified.

In the present embodiment, in the axial direction, the elastic member 416 is disposed at the one end part S1 side of the shaft S with respect to the first bearing 113a. In the axial direction, the elastic member 416 is positioned between the first bearing 113a and the one end part S1 side of the shaft S. Furthermore, in the axial direction, the elastic member 416 is positioned at a predetermined distance D separated from the first bearing 113a toward the one end part S1 side of the shaft S. The cover 414 partially or fully supports an outer circumferential surface of the first bearing 113a through the holder 415. The elastic member 116 is between the one end part 414a of the cover 414 and the holder 415 in the axial direction. A size (outer diameter) of the elastic member 416 in the radial direction is larger than the size (outer diameter) of the cover 414 in the radial direction. Specifically, in the radial direction, an outer circumferential part of the elastic member 416 is larger than an outer surface of the cover 414.

The holder 415 includes an opening part 415e. A space T is formed inside the holder 415 in the radial direction. The first bearing 113a faces this space T in the axial direction. Then, in the radial direction, this space T and the elastic member 416 face each other through the inner circumferential part 415a of the holder 415. In the axial direction, the elastic member 416 is disposed farther at the one end part S1 side of the shaft S than the end surface of the first bearing at one side in the axial direction.

The motor according to the present embodiment has a high coaxiality and a large torque on the basis of a principle similar to the matters described above in the motor 100 according to the first embodiment. The elastic member 416 is disposed at the one end part S1 side of the shaft S with respect to the first bearing 113a, and thus the cover 414 can receive a load applied in the radial direction from the shaft S to the first bearing 113a. Furthermore, the cover 414 can suppress displacement of the first bearing 113a in the radial direction. The holder can hold the elastic member 416 regardless of the size of the elastic member 416, making it possible to select a shape and a material of the elastic member 416 and adjust an elastic force (or spring constant) applied to the cover 414.

### Fifth Embodiment

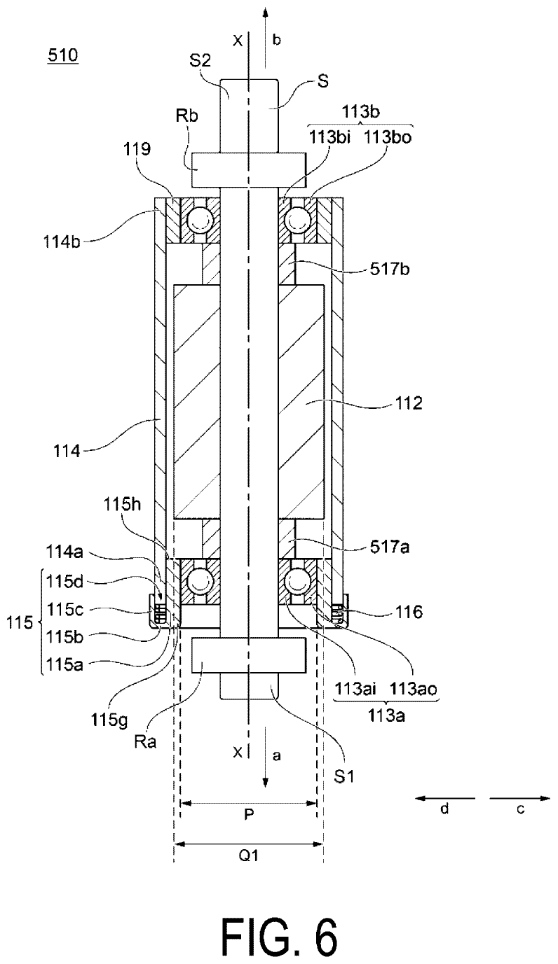

Next, a fifth embodiment being one example of the present invention will be described with reference to the drawings. FIG. 6 is a cross-sectional view of only a bearing device 510 of the motor according to the present embodiment. The motor according to the present embodiment has a configuration similar to the configuration of the motor 100 according to the first embodiment except that the bearing device 510 is provided instead of the bearing device 110. The bearing device 510 has the same configuration as the configuration of the bearing device 110 of the motor 100 according to the first embodiment except for including a member 517a and a member 517b instead of the first pressing member 117a and the second pressing member 117b (however, the bearing device 510 need not include the member 517a and the member 517b), does not include the protective member 118 (however, the bearing device 510 may include the protective member 118), and includes balancers (first ring Ra and second ring Rb). Members and components having the same functions and configurations as the members and components of the first embodiment are given the same reference signs of the first embodiment, and detailed descriptions of the members and components will be omitted below.

The member 517a having an annular shape is disposed between the magnet 112 and the first bearing 113a in the axial direction. The member 517b having an annular shape is disposed between the magnet 112 and the second bearing 113b in the axial direction. The member 517a and the member 517b have the same shape and the same dimensions and are disposed symmetrical with respect to the plane orthogonal to the axis X while sandwiching the magnet 112.

In the radial direction, inner diameters of the members 517a and 517b are equal to the outer diameter of the shaft S or slightly larger than the outer diameter of the shaft S. The members 517a and 517b are fixed to the surface of the shaft S at the outer side in the radial direction (arrow c direction) by bonding or press-fitting. In the radial direction, outer diameters of the members 517a and 517b are smaller than an outer diameter of the magnet 112. In the radial direction, the outer diameters of the members 517a and 517b are slightly larger than outer diameters of the inner ring 113ai of the first bearing 113a and the inner ring 113bi of the second bearing 113b and are slightly smaller than inner diameters of the outer ring 113ao of the first bearings 113a and the outer ring 113bo of the second bearing 113b.

In the axial direction, a surface of the member 517a at the one side (in the arrow a direction) contacts a surface of the inner ring 113ai of the first bearing 113a at the other side (in the arrow b direction). In the axial direction, a surface of the member 517a at the other side (in the arrow b direction) contacts a surface of the magnet 112 at the one side (in the arrow a direction). In the axial direction, a surface of the member 517b at the other side (in the arrow b direction) contacts a surface of the inner ring 113bi of the second bearing 113b at the one side (in the arrow a direction). In the axial direction, a surface of the member 517b at the one side (in the arrow a direction) contacts a surface of the magnet 112 at the other side (in the arrow b direction).

The member 517a and the member 517b bias the inner ring 113ai of the first bearing 113a and the inner ring 113bi of the second bearing 113b, respectively. The member 517a and the member 517b are formed of a metal such as copper, for example. The member 517a and the member 517b may be formed of other materials such as resin or ceramic.

In the axial direction, the first ring Ra is disposed at the one side (in the arrow a direction) of the first bearing 113a so as to be spaced apart from the first bearing 113a. The second ring Rb is disposed at the other side (in the arrow b direction) of the second bearing 113b in the axial direction so as to be spaced apart from the second bearing 113b. In the axial direction, the first ring Ra is disposed further at the one side (in the arrow a direction) than an end part of the cover 114 at the one side (in the arrow a direction). In the axial direction, the second ring Rb is disposed further at the other side (in the arrow b direction) than the end part of the cover 114 at the other side (in the arrow b direction). In other words, the first ring Ra and the second ring Rb are disposed at the outer side of the cover 114 in the axial direction. The motor according to the present embodiment may include only one of the first ring Ra or the second ring Rb.

In the radial direction, sizes of inner circumferential surfaces (inner diameters) of the first ring Ra and the second ring Rb are equal to the outer diameter of the shaft S or slightly larger than the size of an outer circumferential surface (outer diameter) of the shaft S. The first ring Ra and the second ring Rb are fixed to the surface of the shaft S at the outer side in the radial direction (arrow c direction) by adhesion or press-fitting. In the radial direction, sizes of outer circumferential surfaces (outer diameters) of the first ring Ra and the second ring Rb are smaller than an outer diameter of the cover 114. However, in the radial direction, the outer diameters of the first ring Ra and the second ring Rb may be larger than the outer diameter of the cover 114.

The first ring Ra and the second ring Rb are formed of a metal such as copper or non-magnetic bodies. The first ring Ra and the second ring Rb may be formed of other materials but, being capable of serving as balancers configured to adjust the rotational balance of the shaft S, are preferably formed of materials having large specific gravities.

The motor according to the present embodiment has a high coaxiality and a large torque on the basis of a principle similar to the matters described above in the motor 100 according to the first embodiment. Omitting at least one of the first ring Ra or the second ring Rb allows the rotational balance to be adjusted even after the motor according to the present embodiment is assembled. The motor according to the present embodiment, by including the first ring Ra and the second ring Rb, makes it possible to secure a sufficient surplus volume for shaving at the time of adjustment of the rotational balance and improve the rotational balance. The rotational balance can be adjusted by using, for example, a self-propelled balancer.

As described above, the motor according to the present invention has been described with reference to preferred embodiments, but the motor according to the present invention is not limited to the configurations of the embodiments described above. For example, although the case 140 has the cylindrical shape in the above-described embodiments, the case may have any shape in the motor according to the present invention. In the embodiments described above, the bearing devices 110, 210, 310, and 410 include the first pressing member 117a and the second pressing member 117b. However, in the motor according to the present invention, the bearing device may include only one of the pressing members or may not include any pressing member. The first pressing member 117a and the second pressing member 117b do not need to have the same shape and the same dimensions.

In the above-described embodiments, the outer diameters Q1 and Q2 of the magnets 112 and 212 are larger than the outer diameter P of the first bearing 113a and the second bearing 113b. However, in the motor according to the present invention, the outer diameters of the magnets may be equal to the outer diameters of the bearings or smaller than the outer diameters of the bearings. In the above-described embodiments, the second bearing 113b has the same dimensions and configuration as the first bearing 113a, but in the motor according to the present invention, the first bearing and the second bearing may have different dimensions and configurations from each other.

Embodiments for implementing a motor according to the present invention (sixth and seventh embodiments) will be described below together with the accompanying drawings.

The embodiments described below are intended to facilitate the understanding of the present invention and are not intended to be construed as limiting the present invention. The present invention can be modified and improved from the following embodiments without departing from the gist of the present invention. In the above-described accompanying drawings, in order to facilitate understanding, the dimensions of each member may be exaggerated or reduced, or the hatching may be omitted. The motors according to the sixth and seventh embodiments may include a configuration similar to the configurations of the motors according to the first to fifth embodiments, but the names of the members in the motors according to the first to fifth embodiments may differ from the names of the corresponding members of the motors according to the sixth and seventh embodiments for convenience of description.

A known motor includes a stator including a yoke part at an outer circumferential side and a plurality of teeth parts extending to an inner side in the radial direction from this yoke part, a coil being wound around each of the teeth parts (refer to, for example, JP 2012-105397 A). The motor described in the document and other motors may need a high space factor of a coil. The sixth and seventh embodiments are examples to provide a motor wound with a coil at a high space factor.

### Sixth Embodiment

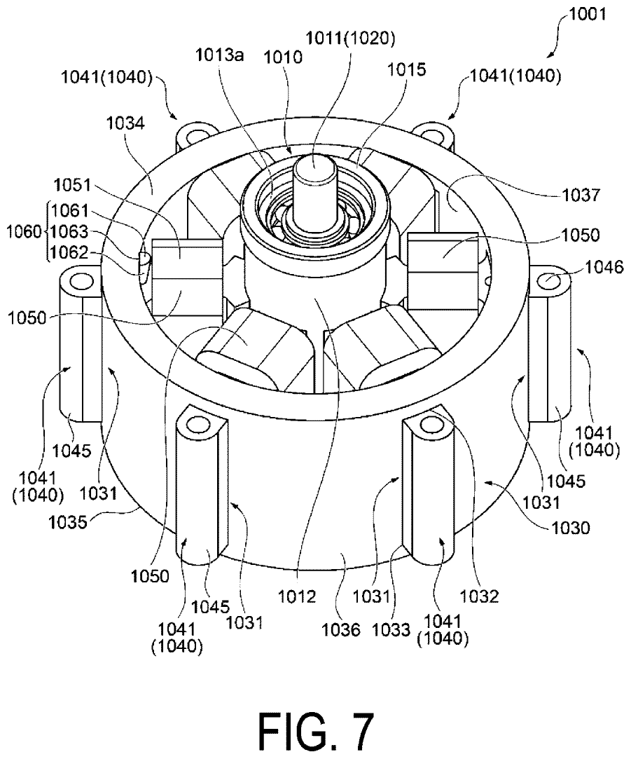

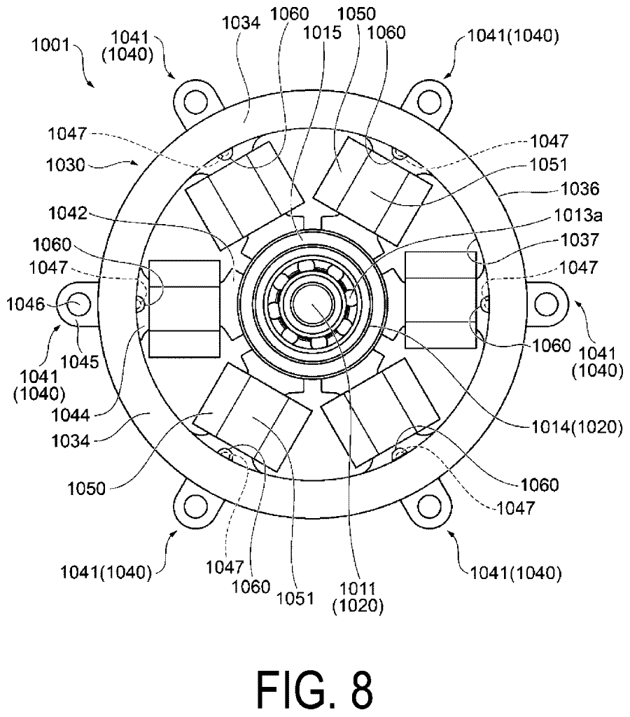

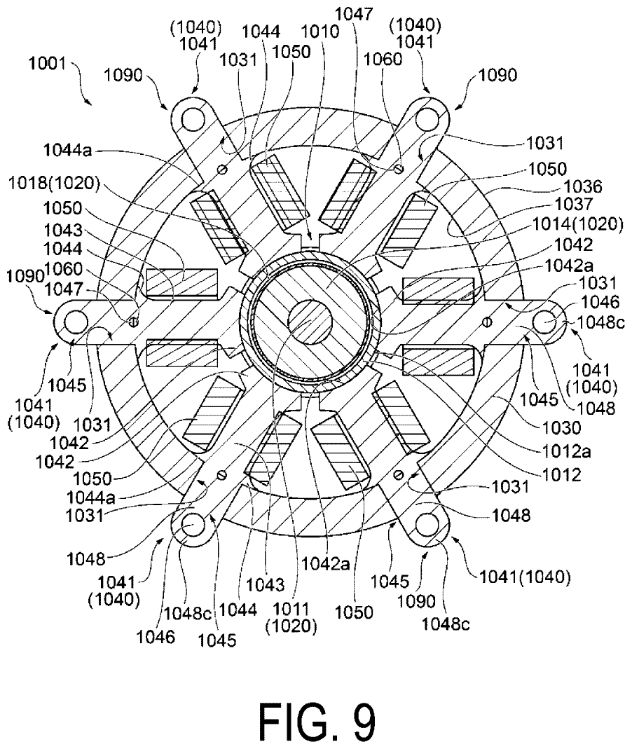

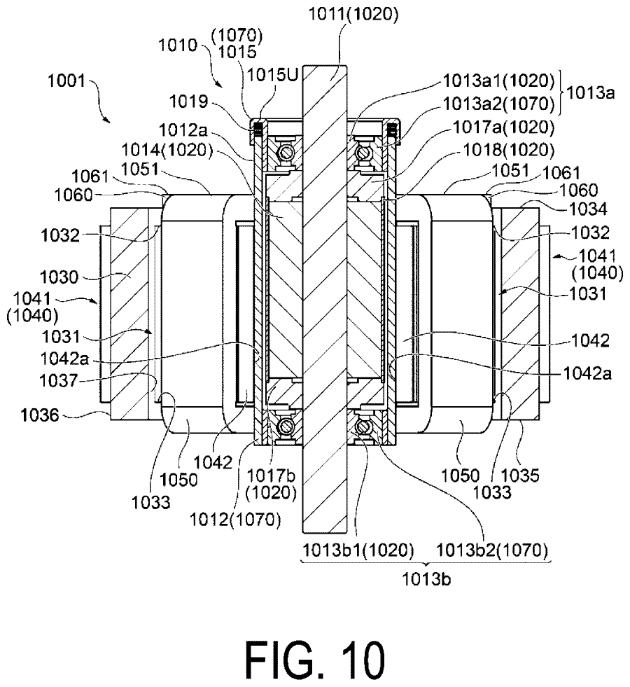

FIG. 7 is a perspective view illustrating a motor 1001 according to the present embodiment. FIG. 8 is a plan view of the motor 1001 as viewed from one side in the axial direction. FIG. 9 is a cross-sectional view of the motor 1001 in the radial direction. FIG. 10 is a cross-sectional view of the motor 1001 in the axial direction.

As illustrated in FIGS. 7 to 10, the motor 1001 has a substantially cylindrical shape as a whole, and includes, as a main configuration, a bearing device 1010 having a cylindrical shape and disposed at a center of the motor 1001, a yoke 1030 having a cylindrical shape (annular shape) surrounding the bearing device 1010, a stator 1040 radially disposed from the bearing device 1010 toward the yoke 1030, a plurality of coils 1050 wound around the stator 1040, and a plurality of pressing members (members) 1060 inserted into hole parts formed in the stator 1040. In FIG. 7, only one pressing member 1060 is illustrated for convenience.

The bearing device 1010 includes a shaft 1011 disposed at the center of the motor 1001 in the radial direction. In the sixth and seventh embodiments, a side close to the shaft 1011 in the radial direction may be referred to as an “inner side” or simply “inner,” and a side far from the shaft 1011 in the radial direction may be referred to as an “outer side” or simply “outer. ” The shaft 1011 is a rotational axis of the motor 1001, and a longitudinal direction of the shaft 1011 is an axial direction of the motor 1001.

As illustrated in FIG. 10, the bearing device 1010 further includes a pair of bearings 1013a and 1013b, a pair of intermediate members 1017a and 1017b, a magnet 1014 having a cylindrical shape, a protective member 1018, a cover 1012 having a cylindrical shape, a holder 1015, and the like.

The cover 1012 accommodates the shaft 1011, the magnet 1014, the pair of bearings 1013a and 1013b, the pair of intermediate members 1017a and 1017b, the magnet 1014, the protective member 1018, and the like inside. That is, the shaft 1011, the magnet 1014, the pair of bearings 1013a and 1013b, the pair of intermediate members 1017a and 1017b, the magnet 1014, the protective member 1018, and the like are disposed inside of an inner circumferential surface of the cover 1012. On the other hand, the stator 1040, the plurality of coils 1050, the yoke 1030, and the like are disposed outward of an outer circumferential surface 1012a of the cover 1012. The cover 1012 may be fixed to a motor case (not illustrated) together with, for example, the yoke 1030. In the present embodiment, the cover 1012 is formed of ceramic. However, the cover 1012 may be formed of another material such as a non-magnetic metal or resin.

In the present embodiment, the pair of bearings 1013a and 1013b are each configured as a ball bearing. However, the pair of bearings 1013a and 1013b may each be any of various other bearings such as, for example, a sleeve bearing, and a ball bearing including balls fitted in recesses in an outer circumferential surface of the shaft and an outer ring. In the axial direction, of the pair of bearings 1013a and 1013b, the bearing 1013a is disposed in the vicinity of an end part of the shaft 1011 at the one side, and the bearing 1013b is disposed in the vicinity of an end part of the shaft 1011 at the other side.

In the sixth and seventh embodiments, one side in the axial direction (bearing 1013a side) may be referred to as an “upper side,” “above,” or simply “upper,” and the other side in the axial direction (bearing 1013b side) may be referred to as a “lower side,” “below,” or simply “lower. ”

The bearing 1013a includes an inner ring 1013a1 and an outer ring 1013a2, and the bearing 1013b includes an inner ring 101b1 and an outer ring 1013b2. The inner rings 101a1 and 101b1 are each fixed to the outer circumferential surface of the shaft 1011 by press-fitting, bonding, or the like, and the outer rings 1013a2 and 1013b2 are each fixed to the inner circumferential surface of the cover 1012 directly or indirectly (through another member).

Each of the pair of intermediate members 1017a and 1017b has an annular shape and is fixed at an inner circumferential surface to the outer circumferential surface of the shaft 1011 by press-fitting, bonding, or the like. In the axial direction, the intermediate member 1017a is disposed at the one side (upper side), and the intermediate member 1017b is disposed at the other side (lower side). The intermediate member 1017a is disposed at the other side (lower side) of the bearing 1013a and presses the inner ring 1013a1 of the bearing 1013a toward the one side (upper side) in the axial direction. The intermediate member 1017b is disposed at the one side (upper side) of the bearing 1013b and presses the inner ring 1013b1 of the bearing 1013b toward the other side (lower side) in the axial direction. The configuration may be changed to only one of the pair of intermediate members 1017a and 1017b being provided.

In the present embodiment, the magnet 1014 is a cylindrical permanent magnet with different magnetic poles (S poles and N poles) being alternately magnetized in the circumferential direction. The magnet 1014 is fixed to the outer circumferential surface of the shaft 1011 by press-fitting, bonding, or the like. In the axial direction, the magnet 1014 is disposed between the pair of bearings 1013a and 13b (between the pair of intermediate members 1017a and 1017b in the present embodiment). In the present embodiment, the protective member 1018 having a cylindrical shape is attached to an outer circumferential surface of the magnet 1014. The protective member 1018 covers the outer circumferential surface of the magnet 1014, thereby preventing breakage or scattering of the magnet 1014. An air gap is formed between an outer circumferential surface of the protective member 1018 and the inner circumferential surface of the cover 1012. Accordingly, the magnet 1014 faces the inner circumferential surface of the cover 1012 through the protective member 1018 and the air gap. The protective member 1018 need not be provided.

The holder 1015 has a cylindrical shape, and an end part 1015U at the one side (upper side) in the axial direction is formed in an inverted U shape. A part of the holder 1015 other than the end part 1015U is interposed between an outer circumferential surface of the outer ring 1013a2 of the bearing 1013a and the inner circumferential surface of the cover 1012. That is, the holder 1015 is fixed to the cover 1012 by being sandwiched between the outer ring 1013a2 and the cover 1012. An upper end part of the cover 1012 is inserted into the end part 1015U of the holder 1015. Inside the end part 1015U of the holder 1015, an elastic member 1019 is accommodated at the one side (upper side) in the axial direction with respect to an upper end of the cover 1012. This elastic member 1019 causes the cover 1012 to be biased toward the other side (lower side) in the axial direction.

In such a motor 1001, the shaft 1011, the inner rings 1013a1 and 1013b1 of the pair of bearings 1013a and 1013b, the magnet 1014, the protective member 1018, and the pair of intermediate members 1017a and 1017b rotate integrally with respect to a stator group 1070 of the motor 1001 via balls of the pair of bearings 1013a and 1013b. That is, in the present embodiment, the shaft 1011, the inner rings 1013a1 and 1013b1 of the pair of bearings 1013a and 1013b, the magnet 1014, the protective member 1018, and the pair of intermediate members 1017a and 1017b constitute a rotor 1020 of the motor 1001. Thus, the motor 1001 operates as a motor of an inner rotor type. On the other hand, the stator group 1070 is a group of elements relatively stationary with respect to the rotation of the shaft 1011. In the present embodiment, this stator group 1070 includes the outer rings 1013a2 and 1013b2 of the pair of bearings 1013a and 1013b, the cover 1012, the holder 1015, the elastic member 1019, the stator 1040, the plurality of coils 1050, the plurality of pressing members 1060, and the yoke 1030.

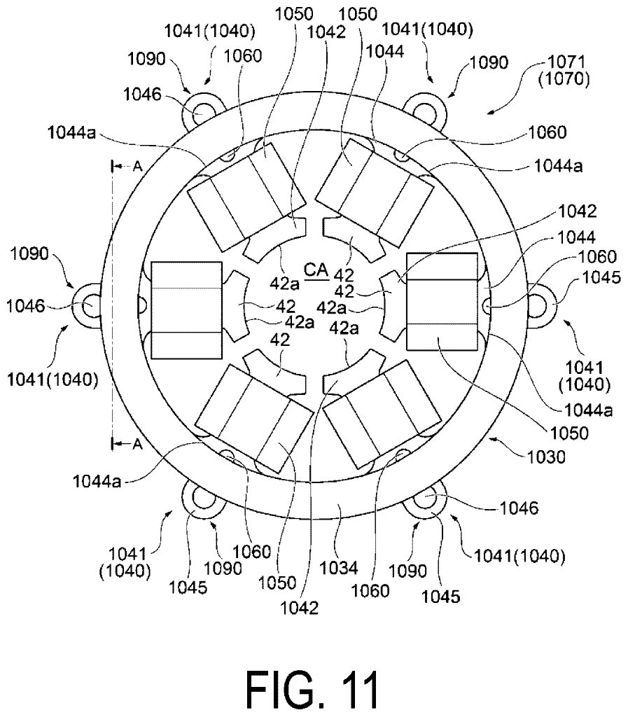

FIG. 11 is a plan view illustrating the motor 1001 with the bearing device 1010 omitted, and illustrates elements (the stator 1040, the plurality of coils 1050, the plurality of pressing members 1060, and the yoke 1030) of the stator group 1070 except for the components of the bearing device 1010 (the outer rings 1013a2 and 1013b2 of the pair of bearings 1013a and 1013b, the cover 1012, the holder 1015, the elastic member 1019, and the like). The elements illustrated in this FIG. 11 are disposed outward of the bearing device 1010, and thus the stator 1040, the plurality of coils 1050, the plurality of pressing members 1060, and the yoke 1030 are hereinafter collectively referred to as an outer stator group 1071. This outer stator group 1071 will be described in detail below.

As illustrated in FIGS. 7 to 11, the yoke 1030 of the outer stator group 1071 is a member having a cylindrical shape (annular shape when viewed in the axial direction) as described above and is formed of a magnetic body. The yoke 1030 includes two end surfaces (upper end surface 1034 and lower end surface 1035) in the axial direction, and two side surfaces (outer circumferential part 1036 and inner circumferential part 1037) in the radial direction. In the yoke 1030, a plurality of openings 1031 (refer to FIG. 9 in particular) penetrating in the radial direction are disposed in the circumferential direction of the yoke 1030. In the present embodiment, six openings 1031 are disposed at equal intervals (intervals of 60°) with respect to the shaft 1011 when viewed in the axial direction. Each of these openings 1031 is formed having the same shape and dimensions. Note that “the same” in the present description includes a difference at a typical manufacturing error level.

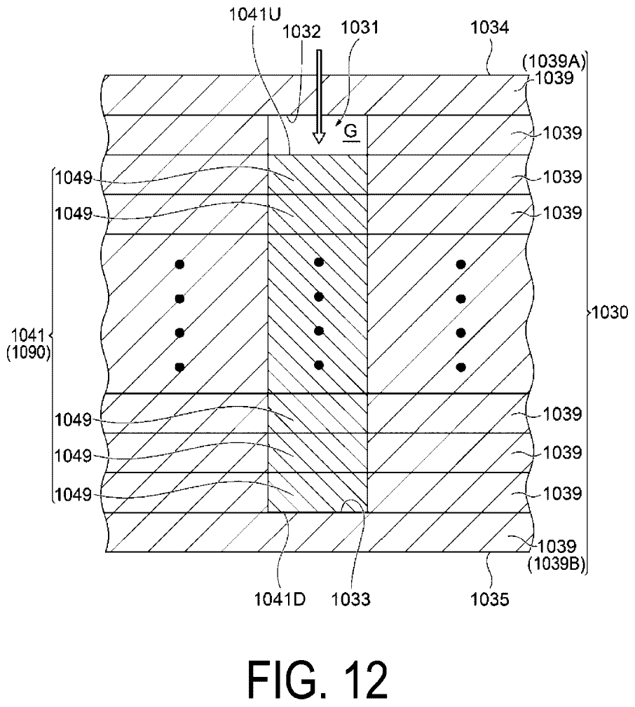

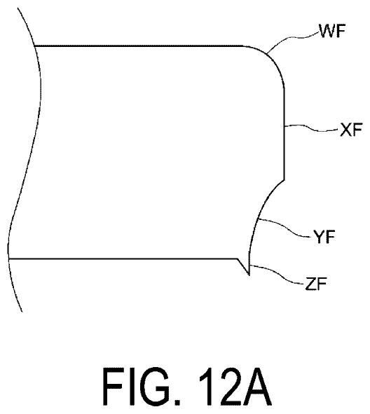

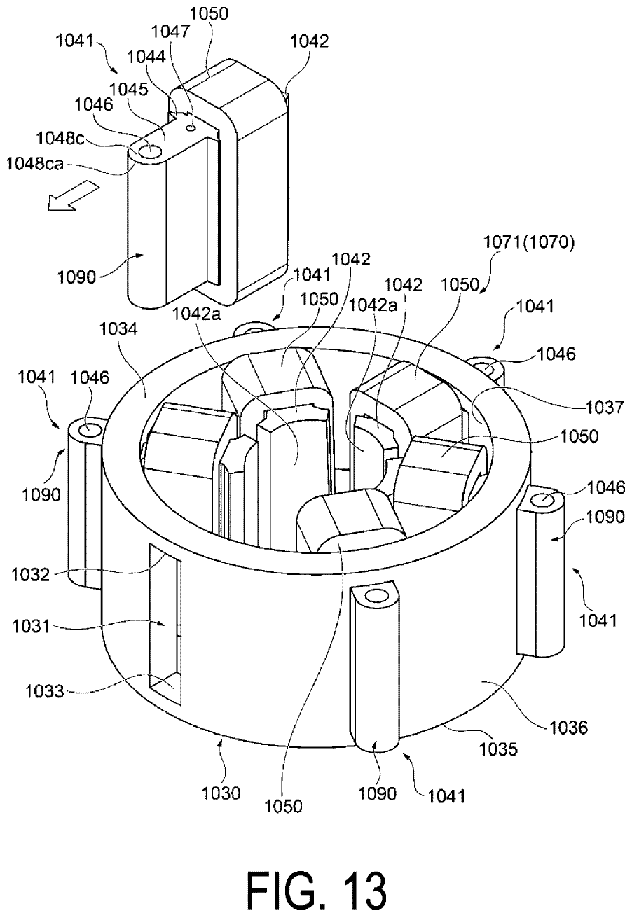

FIG. 12 is a cross-sectional view taken along line A-A illustrated in FIG. 11. FIG. 13 is a perspective view illustrating a state with one of a plurality of stator members 1041 described below in the outer stator group 1071 illustrated in FIG. 11 removed from the yoke 1030.

As illustrated in FIGS. 12 and 13, each of the openings 1031 of the yoke 1030 extends in the axial direction from a part at the lower end surface side with respect to the upper end surface 1034 of the yoke 1030 to a part at the upper end surface 1034 side with respect to the lower end surface 1035 and is formed in a rectangular shape when viewed from the radial direction in the present embodiment. In each of the openings 1031, a length in the axial direction and a length in the circumferential direction of the yoke 1030 are equal in the radial direction. Each of the openings 1031 includes a first inner surface 1032 at the upper end surface 1034 (one end surface) side of the yoke 1030 and a second inner surface 1033 at the lower end surface (other end surface) side of the yoke 1030.

As illustrated in FIG. 12, the yoke 1030 is formed of a plurality of magnetic bodies 1039 having a plate-like shape and stacked in the axial direction. In FIG. 12, the magnetic bodies 1039 excluding the four magnetic bodies 1039 at each of the one side (upper side) in the axial direction and the other side (lower side) in the axial direction are omitted, and this omission is represented by black circles. In the present embodiment, thicknesses of the plurality of magnetic bodies 1039 in the axial direction are equal. However, the thicknesses of the plurality of magnetic bodies 1039 in the axial direction need not be equal. In the present embodiment, each of two inner surfaces of the opening 1031 in the circumferential direction of the yoke 1030 is a surface formed with respective side surfaces in the circumferential direction of the plurality of magnetic bodies 1039 continuous in the axial direction. The plurality of magnetic bodies 1039 exclude the magnetic body 1039 stacked furthest at the one side (upper side) in the axial direction (also referred to as magnetic body 1039A for convenience) and the magnetic body 1039 stacked furthest at the other side (lower side) (also referred to as magnetic body 1039B for convenience). The first inner surface 1032 of the opening 1031 is part of a lower surface of the magnetic body 1039A, and the second inner surface 1033 of the opening 1031 is part of an upper surface of the magnetic body 1039B. Such a yoke 1030 including the plurality of openings 1031 may be manufactured by, for example, stacking the plurality of magnetic bodies 1039 excluding the magnetic bodies 1039A and 1039B in the axial direction, fixing these by caulking or an adhesive to form a stacked body, hollowing out parts corresponding to the plurality of openings 1031 from this stacked body, and lastly fixing the magnetic bodies 1039A and 1039B to one side surface and the other side surface of the stacked body in the axial direction by caulking or an adhesive.

As illustrated particularly in FIGS. 9, 11, and 13, the stator 1040 includes the plurality of stator members 1041 having the same shape and dimensions and formed of the same material. That is, the stator 1040 is composed of the plurality of stator members 1041 separated from each other. In the present embodiment, the stator 1040 includes six stator members 1041. Each of the plurality of stator members 1041 has a symmetrical shape as viewed in the axial direction. Lengths of the stator members 1041 in the axial direction are equal in the radial direction. The stator member 1041 includes a magnetic pole part 1042 and a spoke 1090. That is, the stator 1040 includes a plurality of the magnetic pole parts 1042 and a plurality of the spokes 1090. The coil 1050 is wound around each of the plurality of spokes 1090.

As illustrated in FIG. 12, each of the plurality of stator members 1041 is formed by a plurality of magnetic bodies 1049 having a plate shape and stacked in the axial direction. That is, each of the plurality of magnetic pole parts 1042 and the plurality of spokes 1090 is formed by the plurality of magnetic bodies 1049 stacked in the axial direction. In FIG. 12, the magnetic bodies 1049 excluding the two magnetic bodies 1049 at the one side in the axial direction and the three magnetic bodies 1049 at the other side in the axial direction are omitted, and this omission is represented by black circles. In the present embodiment, thicknesses of the plurality of magnetic bodies 1049 in the axial direction are equal. In the present embodiment, the thickness of each of the plurality of magnetic bodies 1049 in the axial direction is equal to the thickness of each of the plurality of magnetic bodies 1039 forming the yoke 1030 in the axial direction. Furthermore, in the present embodiment, the number of the plurality of magnetic bodies 1049 forming the stator member 1041 (that is, the plurality of magnetic bodies 1049 forming the spokes 1090) is less than the number of the plurality of magnetic bodies 1039 forming the opening 1031 of the yoke 1030 (that is, the plurality of magnetic bodies 1039 excluding the magnetic bodies 1039A and 1039B). In the present embodiment, the number of the plurality of magnetic bodies 1049 forming the spokes 1090 is one less than the number of the plurality of magnetic bodies 1039 forming the opening 1031. Accordingly, the length of the stator member 1041 (spoke 1090) in the axial direction is shorter than a length of the opening 1031 of the yoke 1030 in the axial direction.

The thicknesses of the plurality of magnetic bodies 1049 in the axial direction need not be equal. The thickness of each of the plurality of magnetic bodies 1049 in the axial direction need not be equal to the thickness of each of the plurality of magnetic bodies 1039 forming the yoke 1030 in the axial direction.

The magnetic pole part 1042 of the stator member 1041 is a part at an innermost side of the stator member 1041. The magnetic pole part 1042 is connected to an end part of the spoke 1090 at an inner side. As viewed in the axial direction, the magnetic pole part 1042 in the circumferential direction from an end part of the spoke 1090 at the inner side toward the inner side and has a shape decreasing in length in the circumferential direction toward the inner side. An end surface 1042a of the magnetic pole part 1042 at the inner circumferential side has a shape corresponding to a shape of an outer circumferential surface of the cover 1012 of the bearing device 1010 and is substantially in surface contact with the outer circumferential surface 1012a of the cover 1012. That is, as illustrated in FIG. 11, when the outer stator group 1071 is viewed in the axial direction, the end surfaces 1042a of each of the plurality of magnetic pole parts 1042 are on a circle centered on a center of the motor 1001 (center of the shaft 1011) and, as illustrated in FIG. 9, the circle of these end surfaces 1042a is substantially concentric with the shaft 1011, the magnet 1014, the cover 1012, and the like constituting the bearing device 1010. The end surface 1042a of the magnetic pole part 1042 faces the magnet 1014 through the cover 1012 of the bearing device 1010 and an air gap between the magnet 1014 and the cover 1012. Accordingly, a current being supplied to the coil 1050 wound around the spoke 1090 generates a magnetic interaction between the end surface 1042a of the magnetic pole part 1042 and the magnet 1014. As a result, the rotor 1020 including the shaft 1011 rotates with respect to the stator group 1070.

As illustrated in FIG. 9, the spoke 1090 of the stator member 1041 includes a first part 1043 at the inner side and a second part 1045 outward of the first part 1043.

The first part 1043 of the spoke 1090 has a substantially rectangular shape as viewed in the axial direction, excluding an end part 1044 at an outer side. The coil 1050 is wound around this rectangular part (part excluding the end part 1044 at the outer side) with an insulating part such as an insulator (not illustrated) interposed between the coil 1050 and this rectangular part. The end part 1044 of the first part 1043 at the outer side has a shape extending in the circumferential direction along the outer side. An end surface 1044a of the end part 1044 at the outer side has a shape corresponding to the inner circumferential part 1037 of the yoke 1030, and a length of the end surface 1044a is longer than a length of the opening 1031 of the yoke 1030 in the circumferential direction of the yoke 1030. The end surface 1044a is substantially in surface contact with the inner circumferential part 1037 of the yoke 1030. That is, each of the plurality of spokes 1090 is coupled to the plurality of magnetic pole parts 1042 and the inner circumferential part 1037 of the yoke 1030 having an annular shape.

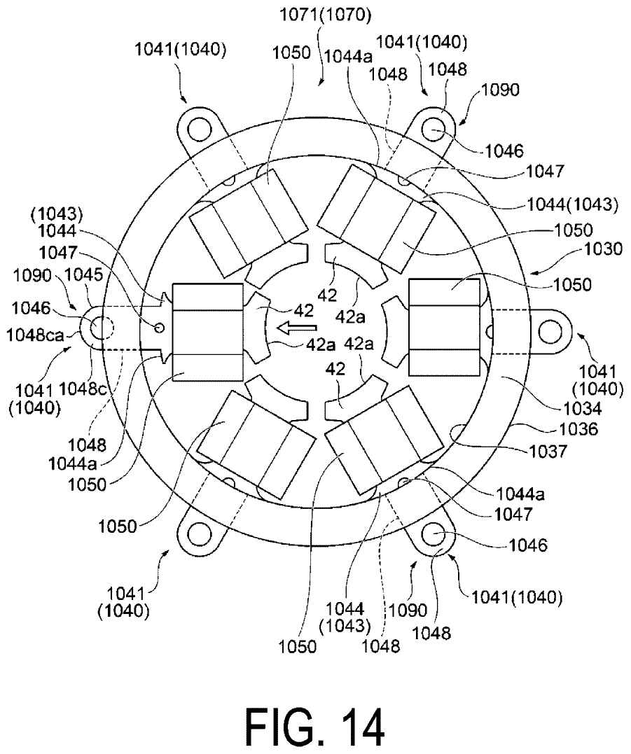

The second part 1045 of the spoke 1090 includes a rectangular part 1048 having a rectangular shape as viewed in the axial direction, and a semicircular part 1048c being a semicircle projecting outward as viewed in the axial direction. An end part of the rectangular part 1048 at the outer side is connected to an end part of a semicircular part 1048c at an inner side, and an end part of the rectangular part 1048 at an inner side is connected to the end part 1044 of the first part 1043 at the outer side. In the circumferential direction of the yoke 1030, a length of the second part 1045 is slightly shorter than a length of the opening 1031 of the yoke 1030 described above. In the radial direction, a length of the second part 1045 is longer than a length of the opening 1031. Accordingly, as illustrated in FIGS. 13 and 14 in particular, the stator member 1041 is inserted into the opening 1031 of the yoke 1030 from the inner side to the outer side of the yoke 1030 with an end part 1048ca of the semicircular part 1048c at the outer side as a leading end, and thus the semicircular part 1048c and part of the rectangular part 1048 pass through the opening 1031 and protrude outward of the yoke 1030. FIG. 14 is a plan view illustrating a state of one of the plurality of stator members 1041 being passed through the opening 1031.

Specifically, when the stator member 1041 is inserted into the opening 1031, the end surface 1044a of the first part 1043 of the spoke 1090 eventually comes into contact with the inner circumferential part 1037 of the yoke 1030, restricting passage of the stator member 1041 further outward. Thus, the insertion of the stator member 1041 into the opening 1031 is completed. With the insertion of the stator member 1041 into the opening 1031 being completed, as illustrated in FIG. 12, part of a lower end surface of the rectangular part 1048 of the second part 1045 (that is, lower end surface 1041D of the stator member 1041) contacts the second inner surface 1033 of the opening 1031, and a gap G is formed between an upper end surface of the rectangular part 1048 of the second part 1045 (that is, upper end surface 1041U of the stator member 1041) and the first inner surface 1032 of the opening 1031. In the present embodiment, a thickness of this gap G in the axial direction is equal to the thickness of one magnetic body 1039 in the axial direction and is also equal to the thickness of one magnetic body 1049 in the axial direction. As illustrated in FIG. 11, when insertion of all stator members 1041 into the openings 1031 is completed, a space CA having a circular shape as viewed in the axial direction is formed at the inner side of the end surface 1042a of each of the plurality of stator members 1041. The bearing device 1010 can be inserted into this space CA from the one side to the other side in the axial direction, for example. On the other hand, the stator member 1041 can be removed from the yoke 1030 by removing the bearing device 1010 and then moving the stator member 1041 from the outer side to the inner side toward the space CA. Thus, each of the plurality of stator members 1041 is attachable to and detachable from the yoke 1030 having an annular shape. That is, each of the plurality of spokes 1090 is attachable to and detachable from the annular yoke 1030 having an annular shape.

As illustrated in FIGS. 13 and 14, in each stator member 1041, the spoke 1090 includes one outer hole part 1046 extending in the axial direction and one inner hole part 1047 extending in the axial direction. That is, the plurality of spokes 1090 of the stator 1040 include a plurality of holes extending in the axial direction. In the present embodiment, the six spokes 1090 include six outer hole parts 1046 and six inner hole parts 1047 as a whole. Each of the plurality of outer hole parts 1046 is outward of each of the plurality of inner hole parts 1047. In the present embodiment, each of outer hole parts 1046 and the inner hole parts 1047 extends from the upper end surface 1041U of the stator member 1041 toward the other side (lower side) in the axial direction. The outer hole parts 1046 and the inner hole parts 1047 may extend from the lower end surface 1041D of the stator member 1041 toward one side (upper side) in the axial direction or may penetrate the stator member 1041 in the axial direction. In the present embodiment, the outer hole parts 1046 and the inner hole parts 1047 are formed in circular shapes when viewed in the axial direction and are formed with respective centers on a straight line passing through a center of the stator member 1041 in the circumferential direction of the yoke 1030. In the present embodiment, the outer hole part 1046 is formed so that a region of substantially one half is positioned in the semicircular part 1048c and a region of substantially the other half is positioned in the rectangular part 1048. On the other hand, the inner hole part 1047 is formed to a diameter smaller than a diameter of the outer hole part 1046 and is formed so that a region of substantially one half is positioned in the rectangular part 1048 (second part 1045) and a region of substantially the other half is positioned in the first part 1043. The inner hole part 1047 does not need to have a diameter smaller than the diameter of the outer hole part 1046 and may have the same diameter or a larger diameter. A positional relationship and respective shapes of the inner hole parts 1047 and the outer hole parts 1046 are not limited to the positional relationship and the shapes described above. For example, the positions of the inner hole parts 1047 may be inside in the radial direction, of the inner circumferential surface of the yoke 1030 having an annular shape in the radial direction, the inner hole parts 1047 may be entirely exposed, the positions of the outer hole parts 1046 may be positions overlapping the yoke 1030 having an annular shape in the radial direction, only part of the outer hole parts 1046 may be exposed, and the shapes of the inner hole parts 1047 and the outer hole parts 1046 may be polygonal shapes including a quadrangular shape, elliptical shapes, or the like.

In the state illustrated in FIGS. 8 and 9 of each of the plurality of stator members 1041 being inserted into the openings 1031 of the yoke 1030, the outer hole parts 1046 are entirely exposed from the yoke 1030 at positions adjacent to the yoke 1030, as viewed from the one side in the axial direction. In the state of FIGS. 8 and 9, the semicircle of the inner hole part 1047 at the inner side is exposed from the yoke 1030 at a position adjacent to the yoke 1030, as viewed from the one side in the axial direction. That is, in the radial direction, each of the plurality of hole parts (outer hole parts 1046 and inner hole parts 1047) is adjacent to the yoke 1030 having an annular shape. In the present embodiment, the pressing member (member) 1060 is inserted into the inner hole part 1047 of each of the plurality of stator members 1041. That is, in the present embodiment, six pressing members 1060 are inserted into the stators 1040.

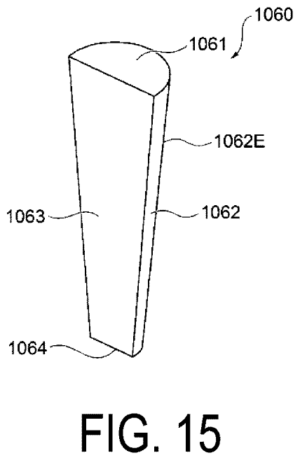

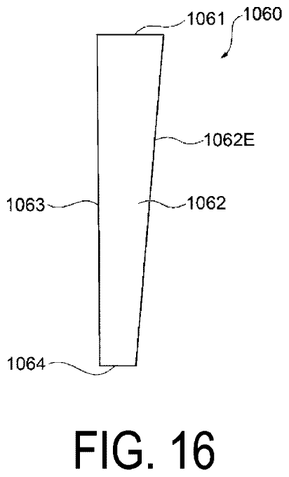

Each of the plurality of pressing members 1060 is formed with the same shape, dimensions, and material. FIG. 15 is a perspective view illustrating the pressing member 1060, and FIG. 16 is a side view illustrating the pressing member 1060. As illustrated in FIGS. 15 and 16, the pressing member 1060 according to the present embodiment is a wedge-like member having a semi-conical shape, and includes a first end surface 1061 and a second end surface 1064 having semi-circular shapes as viewed in the axial direction, a first side surface 1062 being a semi-circular curved surface, and a second side surface 1063 being an isosceles trapezoidal flat surface. The second end surface 1064 has an outer shape smaller than an outer shape of the first end surface 1061. The second side surface 1063 extends in a direction parallel to a longitudinal direction of the pressing member 1060. A ridge line 1062E of the first side surface 1062 is inclined with respect to the longitudinal direction of the pressing member 1060, that is, with respect to the second side surface 1063 so as to approach the second side surface 1063 from the first end surface 1061 side toward the second end surface 1064 side. In the present embodiment, such a pressing member 1060 is inserted into the inner hole part 1047.

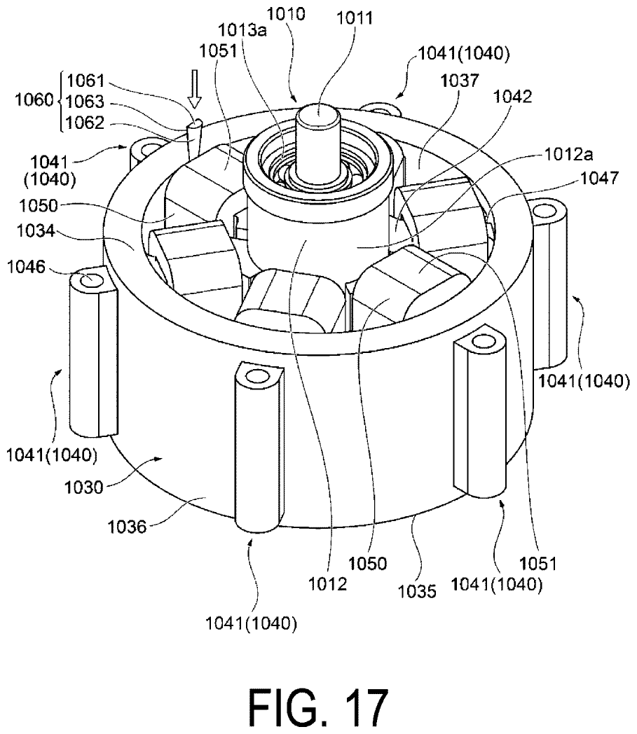

FIG. 17 is a perspective view illustrating a state at the start of insertion of the pressing member 1060 into the inner hole part 1047. As indicated by an arrow in FIG. 17, in the present embodiment, the pressing member 1060 is inserted from the one side (upper side) to the other side (lower side) in the axial direction of the inner hole part 1047. More specifically, the pressing member 1060 is inserted into the inner hole part 1047 with the second end surface 1064 of the pressing member 1060 as a leading end, the first side surface 1062 facing inside, and the second side surface 1063 facing outside. During this insertion, part of the second side surface 1063 is brought into contact with the inner circumferential part 1037 of the yoke 1030. The term “contact” used herein includes not only contact and close contact but also, for example, cases such as part of the pressing member 1060 being engaged with part of the yoke 1030. In the present embodiment, part of the second side surface 1063 is brought into line contact or surface contact with the inner circumferential part 1037. Since the second side surface 1063 of the pressing member 1060 is in line contact or surface contact with the inner circumferential part 1037 in this manner in the present embodiment, the ridge line 1062E of the first side surface 1062 is inclined with respect to the inner circumferential part 1037 being a side surface of the yoke 1030 so as to approach the inner circumferential part 1037 from the one side (upper side) to the other side (lower side) in the axial direction. Then, when the pressing member 1060 is inserted toward the other side (lower side) in the axial direction of the inner hole part 1047 as indicated by the arrow in FIG. 17 while maintaining a state of partial contact of the second side surface 1063 with the inner circumferential part 1037 of the yoke 1030, the first side surface 1062 is inclined with respect to the inner circumferential part 1037 as described above, causing the stator member 1041 to be biased inside by the first side surface 1062 and move inside as the pressing member 1060 is inserted to the lower side. As a result, the end surface 1042a of the magnetic pole part 1042 of the stator member 1041 eventually comes into contact with the outer circumferential surface 1012a of the cover 1012 disposed inside of the stator member 1041 (refer to FIG. 9). In this way, the stator member 1041 is securely positioned in the radial direction, and further insertion of the pressing member 1060 to the lower side is restricted. FIG. 7 illustrates a state of the stator member 1041 being positioned and insertion of the pressing member 1060 to the lower side being restricted. Since each of the plurality of stator members 1041 is positioned in the radial direction by coming into contact with the outer circumferential surface 1012a of the cover 1012 in this manner in the present embodiment, a locus formed by the end surface 1042a of each magnetic pole part 1042 of the plurality of stator members 1041 conforms to a circular locus of the outer circumferential surface 1012a of the cover 1012 when viewed in the axial direction. That is, in the present embodiment, the end surface 1042a of each of the plurality of stator members 1041 is disposed on a circle concentric with the outer circumferential surface 1012a when viewed from the axial direction, and the arrangement of the plurality of stator members 1041 having high circularity is achieved.

In the present embodiment, in the state of FIG. 7 of insertion of the pressing member 1060 to the lower side being restricted, the position in the axial direction of the first end surface 1061 of pressing member 1060 is the same as the position in the axial direction of an upper surface 1051 of the coil 1050 wound around the spoke 1090 or is between the upper surface 1051 of the coil 1050 and the upper end surface 1034 of the yoke 1030. Thus, for example, when a member such as a substrate is disposed at the one side (upper side) in the axial direction with respect to the upper surface 1051 of the coil 1050, such a member such as the substrate can be arranged without interference by the pressing member 1060.

Furthermore, in the state of FIG. 7, the stator member 1041 inserted into the opening 1031 is pressed by the pressing member 1060 in a state of being positioned in the radial direction, and thus is biased to the other side (lower side) in the axial direction as well, as indicated by an arrow in FIG. 12. That is, the plurality of magnetic bodies 1049 forming the spokes 1090 are biased from the upper end surface 1034 (one end surface) side toward the lower end surface 1035 (other end surface) side of the yoke 1030. Accordingly, as a result of the stator member 1041 inserted into the opening 1031 being biased to the other side (lower side) in the axial direction, in other words, as a result of the plurality of magnetic bodies 1049 forming the spokes 1090 being biased from the first inner surface 1032 (inner surface at one end surface side) toward the second inner surface 1033 (inner surface at the other end surface side) of the opening 1031 of the yoke 1030, the stator member 1041 is positioned in the axial direction with a lower surface of the stator member 1041 in surface contact with the upper surface of the magnetic body 1039B of the yoke 1030 (second inner surface 1033 of the opening 1031). As described above, the thickness in the axial direction of each of the plurality of magnetic bodies 1049 forming the stator member 1041 (spoke 1090) is the same as the thickness in the axial direction of each of the plurality of magnetic bodies 1039 forming the yoke 1030, and thus the position of each of the plurality of magnetic bodies 1049 and the position of each of the plurality of magnetic bodies 1039 in the axial direction are the same. More specifically, in the circumferential direction of the yoke 1030, each of the plurality of magnetic bodies 1039 forming the spokes 1090 faces any one of the plurality of magnetic bodies 1049 forming the yoke 1030 without being displaced in the axial direction. In this way, in the present embodiment, a position of a boundary between a pair of the magnetic bodies 1049 and 1049 adjacent to each other in the axial direction and a position of a boundary between a pair of the magnetic bodies 1039 and 1039 adjacent to each other in the axial direction are the same. As described above, in the present embodiment, the number of the plurality of magnetic bodies 1049 forming the spokes 1090 is one less than the number of the plurality of magnetic bodies 1039 forming the opening 1031 of the plurality of magnetic bodies 1039 forming the yoke 1030, and the thickness of the gap G in the axial direction described above is thus equal to the thickness of one magnetic body 1049 and is equal to the thickness of one magnetic body 1039.

As described above, the motor 1001 according to the present embodiment includes the yoke 1030 having an annular shape and including the two end surfaces (upper end surface 1034 and lower end surface 1035) in the axial direction, and the stator 1040. The stator 1040 of this motor 1001 includes the plurality of magnetic pole parts 1042, the plurality of spokes 1090 coupled to the plurality of magnetic pole parts 1042 and the inner circumferential part 1037 of the yoke 1030 having an annular shape, and the plurality of coils 1050 wound around the plurality of spokes 1090. Then, in the motor 1001, each of the plurality of spokes 1090 is attachable to and detachable from the yoke 1030, the yoke 1030 and each of the plurality of spokes 1090 are formed of the plurality of magnetic bodies 1039 and 1049 stacked in the axial direction, and the plurality of magnetic bodies 1049 forming the spokes 1090 are biased from the one end surface (upper end surface 1034) side to the other end surface (lower end surface 1035) side of the two end surfaces (upper end surface 1034 and lower end surface 1035) of the Yoke 1030.

In such a motor 1001, each of the plurality of spokes 1090 (that is, stator members 1041) is attachable to and detachable from the yoke 1030, making it possible to wind the coil 1050 around the spoke 1090 before the spoke 1090 is inserted into the yoke 1030. That is, the coil 1050 can be wound around the spoke 1090 without interference by another spoke 1090 adjacent in the circumferential direction. Accordingly, the coil 1050 can be wound at a high space factor, and the motor 1001 is a motor wound with the coil at a high space factor.

In the motor 1001, the plurality of magnetic bodies 1049 forming the spokes 1090 are biased from the one end surface (upper end surface 1034) side of the two end surfaces (upper end surface 1034 and lower end surface 1035) of the yoke 1030 toward the other end surface (lower end surface 1035) side as described above, the position of each of the plurality of magnetic bodies 1049 and the position of each of the plurality of magnetic bodies 1039 are thus the same in the axial direction in each of the plurality of openings 1031 of the yoke 1030, and the position of the boundary between the pair of magnetic bodies 1049 and 1049 adjacent to each other in the axial direction and the position of the boundary between the pair of the magnetic bodies 1039 and 1039 adjacent to each other are the same in the axial direction. In such a configuration, when a magnetic flux is generated in each of the plurality of magnetic bodies 1049 forming the spokes 1090 by the coil 1050 wound around the spoke 1090, these magnetic fluxes can be transmitted to the plurality of magnetic bodies 1039 forming the yoke 1030 without being obstructed by the boundary between the pair of magnetic bodies 1039 and 1039 adjacent to each other. Accordingly, the motor 1001 suppresses deviation of a magnetic path and can achieve, for example, high efficiency.

Even when the thicknesses of each of the plurality of magnetic bodies 1039 are not the same, the thicknesses of the plurality of magnetic bodies 1049 are not the same, or the thicknesses of each of the plurality of magnetic bodies 1049 in the axial direction and the thicknesses of each of the plurality of magnetic bodies 1039 forming the yoke 1030 in the axial direction are not the same, the plurality of magnetic bodies 1049 forming the spokes 1090 are securely positioned in the openings 1031 of the plurality of magnetic bodies 1049 in the axial direction by being biased from the one end surface (upper end surface 1034) of the two end surfaces (upper end surface 1034 and lower end surface 1035) of the yoke 1030 toward the other end surface (lower end surface 1035) as long as the degree of not being the same is within a normally anticipated range, and thus the position of the boundary between the pair of magnetic bodies 1049, 1049 adjacent to each other in the axial direction and the position of the boundary between the pair of magnetic bodies 1039 and 1039 adjacent to each other in the axial direction substantially coincides. This suppresses deviation of the magnetic path and can achieve, for example, high efficiency.

In the present embodiment, the side surfaces of the plurality of magnetic bodies 1039 having a plate-like shape and the plurality of magnetic bodies 1049 forming the opening 1031 are as illustrated in FIG. 12A. When each of the magnetic bodies 1039 and 1049 is formed, one magnetic body is placed on a mold (so-called die), pressed from above the magnetic body by another mold (so-called punch) to apply a force and cut the magnetic body to a predetermined size to obtain the magnetic bodies 1039 and 1049. The side surfaces of the magnetic bodies 1039 and 1049 obtained by pressing in this manner include curved surfaces WF (so-called sags), sheared surfaces XF (cut surfaces) extending in the axial direction, fractured surfaces YF recessed toward the inner sides of the magnetic bodies 1039 and 1049, and protruding parts ZF (so-called burrs) from the fractured surfaces. Among the curved surfaces WF, the sheared surfaces XF, the fractured surfaces YF, and the protruding parts ZF forming the side surfaces of the plurality of magnetic bodies 1039 and 1049, the sheared surface XF of the magnetic body 1039 and the sheared surface XF of the magnetic body 1049 contact each other, forming the magnetic path. The sheared surface XF of each of the magnetic bodies 1039 and 1049 occupy 30% to 50% of the overall side surfaces of the magnetic bodies 1039 and 1049. Therefore, the thicknesses of the magnetic bodies 1039 and 1049 are preferably substantially equal to an extent that the sheared surfaces XF of each of the magnetic bodies 1039 and 1049 can come into contact with each other.

### Seventh Embodiment

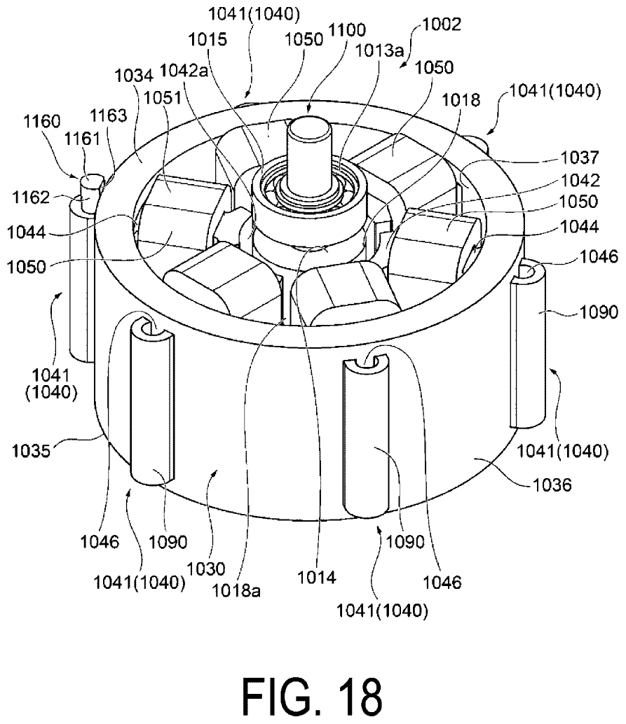

Next, a motor 1002 according to the seventh embodiment will be described. FIG. 18 is a perspective view illustrating the motor 1002 according to the present embodiment. As illustrated in FIG. 18, the motor 1002 according to the present embodiment has substantially the same configuration as the configuration of the motor 1001 according to the sixth embodiment, but is mainly different from the motor 1001 according to the sixth embodiment in the configuration of the bearing device, the configuration of the pressing member, and the position of insertion of the pressing member. Accordingly, in the following, only these differences will be described. The other configurations will be denoted by the same reference signs as the reference signs of the sixth embodiment, and descriptions of the other configurations will be omitted.

As illustrated in FIG. 18, unlike the bearing device 1010 of the motor 1001, a bearing device 1100 of the motor 1002 does not include a cover such as the cover 1012. Accordingly, in the motor 1002, the magnet 1014 having a cylindrical shape and the protective member 1018 are exposed, and the protective member 1018 faces the end surface 1042a of the magnetic pole part 1042 of the stator member 1041 through an air gap. In the motor 1002, the outer rings 1013a2 and 1013b2 of the pair of bearings 1013a and 1013b and the like (that is, members constituting the stator group 1070) may be directly or indirectly fixed to, for example, a housing (not illustrated).

In the motor 1002 as well, similar to the motor 1001, the spokes 1090 (stator members 1041) are inserted into the respective plurality of openings 1031 of the yoke 1030. In the motor 1002, similar to the motor 1001, the plurality of magnetic bodies 1049 forming the spokes 1090 are biased by the pressing member from the upper end surface 1034 side toward the lower end surface 1035 side of the yoke 1030. However, in the motor 1002, a pressing member 1160 different from the pressing member 1060 is used as the pressing member and, unlike the motor 1001, the pressing member 1160 is inserted into the outer hole part 1046 of the spoke 1090 (stator member 1041).

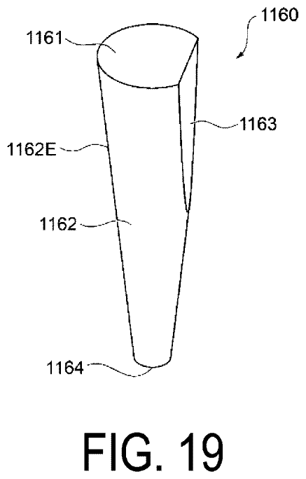

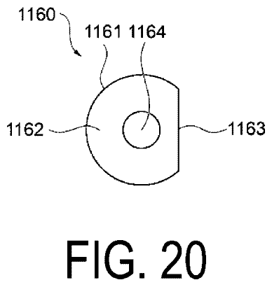

FIG. 19 is a perspective view illustrating the pressing member 1160, and FIG. 20 is a bottom view. As illustrated in FIGS. 19 and 20, the pressing member 1160 has a shape obtained by cutting, parallel to the longitudinal direction of the pressing member 1160, part of the top surface of a truncated cone member including a top surface having a large diameter and a bottom surface having a small diameter. That is, the pressing member 1160 includes a first end surface 1161 at one side and a second end surface 1164 at the other side in the longitudinal direction of the pressing member 1160, a first surface 1162 occupying most of the side surface of the pressing member 1160, and a second surface 1163 being a surface of the side surface of the pressing member 1160 excluding the first surface 1162. The second end surface 1164 has a circular shape when the pressing member 1160 is viewed from the longitudinal direction. When the pressing member 1160 is viewed from the longitudinal direction, the first end surface 1161 has a shape obtained by cutting off part of a circle having a larger diameter than a diameter of the second end surface 1164 and has a larger area than an area of the second end surface 1164. The first surface 1162 is a curved surface of a surface obtained by removing, in a direction parallel to the longitudinal direction of the pressing member 1160 from the first end surface 1161, part of a conical surface having a diameter decreasing from the first end surface 1161 toward the second end surface 1164. The second surface 1163 is a flat surface parallel to the longitudinal direction of the pressing member 1160 of the surface removed. When the pressing member 1160 is viewed from the side, the ridge line 1162E of the first surface 1162 is inclined with respect to the second surface 1163 parallel to the longitudinal direction of the pressing member 1160 so as to approach a central axis of the pressing member 1160 from the first end surface 1161 toward the second end surface 1164. The central axis of the pressing member 1160 is a straight line passing through centers of the first end surface 1161 and the second end surface 1164 and extending in the longitudinal direction of the pressing member 1160.

In the motor 1002, as illustrated in FIG. 18, such a plurality of (six in the present embodiment) pressing members 1160 are respectively inserted into the plurality of (six in the present embodiment) outer hole parts 1046. In FIG. 18, only one pressing member 1160 is illustrated for convenience. Specifically, the pressing member 1160 is inserted from the one side (upper side) to the other side (lower side) in the axial direction of the outer hole part 1046. More specifically, the pressing member 1160 is inserted into the outer hole part 1046 with the second end surface 1164 of the pressing member 1160 as a leading end, the second surface 1163 facing inside, and the first surface 1162 facing outside. During this insertion, part of the second surface 1163 is brought into contact with the outer circumferential part 1036 of the yoke 1030. The term “contact” used herein includes not only contact and close contact but also, for example, cases such as part of the pressing member 1160 being engaged with part of the yoke 1030. In the present embodiment, part of the second surface 1163 is brought into line contact or surface contact with the outer circumferential part 1036. Since the second surface 1163 of the pressing member 1160 is in line contact or surface contact with the outer circumferential part 1036 in this manner in the present embodiment, the ridge line 1162E of the first surface 1162 is inclined with respect to the outer circumferential part 1036 being a side surface of the yoke 1030 so as to approach the outer circumferential part 1036 from the one side (upper side) to the other side (lower side) in the axial direction. Then, when the pressing member 1160 is inserted toward the lower side of the outer hole part 1046 while maintaining a state of partial contact of the second surface 1163 with the outer circumferential part 1036 of the yoke 1030, the first surface 1162 is inclined with respect to the outer circumferential part 1036 as described above, causing the stator member 1041 to be biased outward by the first surface 1162 and move outward as the pressing member 1160 is inserted to the lower side. As a result, the end surface 1044a (refer to FIG. 14) of the end part 1044 at the outer side of the first part 1043 of the spoke 1090 eventually comes into contact with the inner circumferential part 1037 of the yoke 1030. Thus, the stator member 1041 is securely positioned in the radial direction, and further insertion of the pressing member 1160 to the lower side is restricted. FIG. 18 illustrates a state of the stator member 1041 being positioned and insertion of the pressing member 1060 to the lower side being restricted. In the present embodiment, in this state of FIG. 18, the position in the axial direction of the first end surface 1161 of pressing member 1160 is the same as the position in the axial direction of the upper surface 1051 of the coil 1050 wound around the spoke 1090 or is between the upper surface 1051 of the coil 1050 and the upper end surface 1034 of the yoke 1030.

Furthermore, in the state of FIG. 18, the stator member 1041 inserted into the opening 1031 is pressed by the pressing member 1160 in a state of being positioned in the radial direction, and thus is biased to the other side (lower side) in the axial direction as indicated by the arrow in FIG. 12. That is, the plurality of magnetic bodies 1049 forming the spokes 1090 are biased from the upper end surface 1034 (one end surface) side toward the lower end surface 1035 (other end surface) side of the yoke 1030. Accordingly, as a result of the stator member 1041 inserted into the opening 1031 being biased to the lower side, in other words, as a result of the plurality of magnetic bodies 1049 forming the spokes 1090 being biased from the first inner surface 1032 (inner surface at one end surface side) toward the second inner surface 1033 (inner surface at the other end surface side) of the opening 1031 of the yoke 1030, the stator member 1041 is positioned in the axial direction with the lower surface of the stator member 1041 in surface contact with the upper surface of the magnetic body 1039B of the yoke 1030 (second inner surface 1033 of the opening 1031).

As described above, the motor 1002 according to the present embodiment includes the yoke 1030 having an annular shape and including the two end surfaces (upper end surface 1034 and lower end surface 1035) in the axial direction, and the stator 1040. The stator 1040 of this motor 1002 includes the plurality of magnetic pole parts 1042, the plurality of spokes 1090 coupled to the plurality of magnetic pole parts 1042 and the inner circumferential part 1037 of the yoke 1030 having an annular shape, and the plurality of coils 1050 wound around the plurality of spokes 1090. Then, in the motor 1002, each of the plurality of spokes 1090 is attachable to and detachable from the yoke 1030, the yoke 1030 and each of the plurality of spokes 1090 are formed of the plurality of magnetic bodies 1039 and 1049 stacked in the axial direction, and the plurality of magnetic bodies 1049 forming the spokes 1090 are biased from one end surface (upper end surface 1034) side to the other end surface (lower end surface 1035) side of the two end surfaces (upper end surface 1034 and lower end surface 1035) of the yoke 1030.

In such a motor 1002, each of the plurality of spokes 1090 (that is, stator members 1041) is attachable to and detachable from the yoke 1030, allowing the coil 1050 to be wound around the spoke 1090 before the spoke 1090 is inserted into the yoke 1030. Accordingly, as with the motor 1001, the coil 1050 can be wound at a high space factor, and the motor 1002 is a motor wound with the coil at a high space factor.

As described above, the motor 1002 causes the plurality of magnetic bodies 1049 forming the spokes 1090 to be biased from a side of one end surface (upper end surface 1034) toward the other end surface (lower end surface 1035) of the two end surfaces (upper end surface 1034 and lower end surface 1035) of the yoke 1030, and thus, similar to the motor 1001, the magnetic flux generated by the coil 1050 in each of the plurality of magnetic bodies 1049 can be transmitted to the plurality of magnetic bodies 1049 without being obstructed by the boundary between, among the plurality of magnetic bodies forming the yoke 1030, the pairs of magnetic bodies 1039 and 1039 adjacent to each other in the axial direction. Accordingly, the motor 1002 suppresses deviation of the magnetic path and can achieve, for example, high efficiency.

While the embodiment described above illustrates another motor according to the present invention by way of example, the present invention is not limited to this example.

For example, although an example of the plurality of magnetic bodies 1049 forming the spokes 1090 being biased from the one side to the other side in the axial direction has been described in the embodiment described above, the plurality of magnetic bodies 1049 may be biased from the other side to the one side in the axial direction.

The pressing member described in the embodiments described above is not limited to the pressing members 1060 and 1160 as long as the plurality of magnetic bodies 1049 forming the spokes 1090 can be biased from one end surface side of the two end surfaces (upper end surface 1034 and lower end surface 1035) of the yoke 1030 toward the other end surface side, and a pressing member having another shape or configuration may be used. The plurality of magnetic bodies 1049 forming the spokes 1090 may be biased from one end surface side of the two end surfaces (upper end surface 1034 and lower end surface 1035) of the yoke 1030 toward the other end surface side without using the pressing member.

In addition, the motor according to the present invention can be appropriately modified and the shapes, the dimensions, and the combinations of the various configurations can be modified, by a person skilled in the art according to previously known knowledge. Such modifications are of course included in the scope of the present invention as long as these modifications still include the configurations of the present invention.

### Reference Signs List

100 Motor, 112, 212 Magnet, 113a First bearing, 113b Second bearing, 114, 314, 414 Cover, 115, 415 Holder, 115d, 415d Accommodating part, 116, 416 Elastic member, 117a, 117b Pressing member, 118 Protective member, 119 Spacer, 120 Coil, S Shaft, 1001, 1002 Motor, 1030 Yoke, 1031 Opening, 1032 First inner surface (inner surface), 1033 Second inner surface (inner surface), 1034 Upper end surface (end surface), 1035 Lower end surface (end surface), 1036 Outer circumferential part (side surface), 1037 Inner circumferential part (side surface), 1039 Magnetic body, 1040 Stator, 1042 Magnetic pole part, 1046 Outer hole part (hole part), 1047 Inner hole part (hole part), 1049 Magnetic body, 1050 Coil, 1060, 1160 Pressing member (member), 1090 Spoke.

1. A motor, comprising:
a shaft;
a magnet;
a coil;
a first bearing disposed at a side of one end part of the shaft in an axial direction;
a second bearing disposed at a side of the other end part of the shaft in the axial direction;
a cover fixed to the second bearing and disposed inside the coil in a radial direction;
a holder fixed to the first bearing; and
an elastic member held by the holder,
wherein the elastic member is disposed between the cover and the holder in a longitudinal direction of the shaft.

2. The motor according to claim 1, wherein the magnet is disposed inside the cover in the radial direction.

3. The motor according to claim 1, wherein the holder includes an accommodating part accommodating the elastic member.

4. The motor according to claim 1, wherein the elastic member biases the holder in the axial direction.

5. The motor according to claim 1, comprising
a pressing member disposed between the magnet and the first bearing and configured to press an inner ring of the first bearing.

6. The motor according to claim 5, wherein the pressing member is a balancer configured to adjust a rotational balance of the shaft.

7. The motor according to claim 1, wherein the cover covers the first bearing and the second bearing in the radial direction.

8. The motor according to claim 1, comprising
a protective member configured to cover an outer side of the magnet in the radial direction.

9. The motor according to claim 1, wherein a size of the magnet in the radial direction is larger than a size of the first bearing or the second bearing in the radial direction.

10. The motor according to claim 1, wherein the cover is fixed to the second bearing through a spacer.

11. The motor according to claim 1, wherein the elastic member is disposed at the side of the one end part of the shaft with respect to the first bearing in the axial direction.

12. The motor according to claim 11, wherein the elastic member is positioned between the first bearing and the one end part of the shaft in the axial direction.

13. The motor according to claim 12, wherein the elastic member is positioned at a predetermined distance separated from the first bearing toward the side of the one end part of the shaft in the axial direction.

14. The motor according to claim 13, wherein the elastic member is between an end part at one side of the cover and the holder in the axial direction.

15. The motor according to claim 14, wherein a size of the elastic member in the radial direction is larger than a size of the cover in the radial direction.

16. A motor, comprising:
an annular yoke including two end surfaces in an axial direction; and
a stator including a plurality of magnetic pole parts, a plurality of spokes coupled to the plurality of magnetic pole parts and an inner circumferential part of the annular yoke, and a plurality of coils wound around the plurality of spokes,
wherein each of the plurality of spokes is attachable to and detachable from the annular yoke,
the annular yoke and each of the plurality of spokes are formed of a plurality of magnetic bodies stacked in the axial direction, and
the plurality of magnetic bodies forming the spokes are biased from a side of one end surface toward a side of the other end surface of the two end surfaces of the annular yoke.

17. The motor according to claim 16, wherein the plurality of magnetic bodies forming the spokes are biased in a radial direction.

18. The motor according to claim 16,
wherein the annular yoke includes a plurality of openings disposed in a circumferential direction,
each of the plurality of openings includes an inner surface at the side of the one end surface of the annular yoke and an inner surface at the side of the other end surface of the annular yoke,
the plurality of spokes extend in the radial direction and pass through the plurality of openings, and
the plurality of magnetic bodies forming the spokes are biased from the inner surface at the side of the one end surface of the annular yoke toward the inner surface at the side of the other end surface of the annular yoke.

19. The motor according to claim 18, wherein the number of the plurality of magnetic bodies forming the spokes is less than the number of a plurality of magnetic bodies forming the plurality of openings of the plurality of magnetic bodies forming the annular yoke.

20. The motor according to claim 16,
wherein the plurality of spokes include a plurality of hole parts extending in the axial direction, and
members inserted into the plurality of hole parts bias the plurality of magnetic bodies forming the spokes.

21. The motor according to claim 20, wherein each of the plurality of hole parts is adjacent to the annular yoke in the radial direction.

22. The motor according to claim 21, wherein each of the members contacts a side surface of the annular yoke.

23. The motor according to claim 21, wherein each of the members includes a side surface inclined relative to a side surface of the annular yoke.

24. The motor according to claim 16, wherein a thickness in the axial direction of each of the plurality of magnetic bodies forming the spokes is equal to a thickness in the axial direction of each of the plurality of magnetic bodies forming the annular yoke.
